(19) United States
(12) Patent Application Publication
(10) Pub. No.: US 2025/0282646 A1
(43) Pub. Date: Sep. 11, 2025

(54) PORTABLE INSULATED WATER TREATMENT MODULES AND SYSTEMS FOR PURIFYING WATER

(71) Applicant: DOWCLEAR INC., MANOTICK (CA)

(72) Inventors: JASON DOWNEY, MANOTICK (CA); ARDJAN MUCA, MANOTICK (CA)

(21) Appl. No.: 18/860,086

(22) PCT Filed: Apr. 27, 2023
(86) PCT No.: PCT/CA2023/050569

§ 371 Date: Oct. 25, 2024

Related U.S. Application Data
(60) Provisional application No. 63/335,500, filed on Apr. 27, 2022.

(51) Int. Cl. C02F 1/00; B65D 19/02; B65D 21/02; B65D 81/38; C02F 1/52; C02F 1/68; C02F 103/00

(52) U.S. Cl. CPC C02F 1/008; B65D 19/02; B65D 21/0217; B65D 81/3816; B65D 81/3823; C02F 1/001; C02F 1/5209; C02F 1/685; C02F 2103/007; C02F 2201/007; C02F 2201/008; C02F 2209/008; C02F 2209/02

(57) ABSTRACT

Mobile water treatment modules are disclosed that are designed as building blocks that can be assembled together in parallel and/or series to form larger more complex water treatment processes for site specific applications. Mobile water treatment modules can be customized for project specific requirements and for client preferred features. The treatment modules typically used as building blocks include, but are not limited to, pumping modules, chemical dosing modules, chemical storage tank modules, sludge wasting modules, valve modules, pumping tank modules, filtering modules, and well head enclosure modules.

### CROSS-REFERENCE TO RELATED APPLICATIONS

This application claims the benefit of priority as a 371 National Phase Entry application of PCT/CA2023/050569 filed Apr. 27, 2023; which itself claims the benefit of priority to U.S. Provisional Application No. 63/335,500 filed Apr. 27, 2022, the contents of each being incorporated herein by reference in their entirety.

### FIELD OF THE INVENTION

The present invention relates generally to the field of modular water treatment units, specifically to modular configurations of portable water treatment modules, more specifically to portable insulated water treatment modules and systems of use.

### BACKGROUND

Any discussion of the related art throughout the specification should in no way be considered as an admission that such related art is widely known or forms part of common general knowledge in the field.

To supply a system for treating contaminated surface water, industrial wastewater or groundwater, a customized treatment process is required as each project and site is faced with a different set of contaminants, effluent objectives, flow rates. The treatment process is custom designed with multiple treatment stages to overcome the various compounds requiring treatment. Stages may include a wide range of technologies and treatment methods including storage tanks, equalization tanks, aeration, air stripping, chemical reaction processes, media adsorption, depth media filtration, coagulation, flocculation, clarification, gravity oil water separation, dissolved air flotation, bag filtration, cartridge filtration, paper filtration, sludge thickening, sludge dewatering, laydown style solids settling and filtration bags.

Mobile Water treatment systems are typically custom manufactured and supplied in the industry by housing the equipment in either a modified ISO shipping container, a mobile trailer, an engineered for purpose mobile prefabricated building/enclosure or on open steel skids. These systems are automated and controlled through a centralized power distribution and control systems to provide an integrated automated treatment process with remote and local monitoring capability. These treatment systems are typically custom manufactured for the specific application which requires engineering for purpose a treatment process, purchasing the specified subcomponents, manufacturing, pre-piping and prewiring the subcomponents, and testing the plant prior to deployment.

With the increased purchasing pressure in the marketplace, the materials required for building custom plants have doubled both delivery time frames and manufacturing costs. These delays and cost overruns have created challenges to the clients' requiring solutions and provided opportunity for new inventions to satisfy the changing market.

These custom manufactured water treatment systems have limitations including, long delivery cycles, high cost of manufacture, expensive and time consuming to integrate and automate as a large treatment process. Furthermore, these systems are expensive to ship and handle given they require dedicated flatbed trucks and cranes for loading and offloading.

For temporary mobile water treatment applications with tight schedules simplified treatment systems can be assembled on sites using subcomponents available through rental supply companies in the market. Individual items including tanks, settling tanks, mixing tanks, mobile clarifiers, sand filter skids, bag filter housings, media filters, and pumps are available for rental that can be assembled on a site to form a temporary treatment process. These temporary solutions have limitations including high operating labor costs, little to no automation, and not suitable for cold weather operation and have only limited treatment stages.

Thus, it would be desirable to develop an alternate solution to assembly a customized, premanufactured and automated water process where the shipping and handling costs were greatly reduced, the manufacturing costs were greatly reduced and the typical delivery schedules were greatly reduced with the equipment housed inside an insulated enclosure suitable for cold weather operation and providing security for the equipment to prevent unwanted vandalism or tampering with key equipment.

U.S. Application No: 2014/0144820 to Early et al., discloses a rapid deployable packaged wastewater treatment system. The rapid deployable packaged wastewater treatment system is a low-energy demanding, portable, rapidly deployable and operational wastewater treatment system utilizing a plastic vessel including an acrobic pretreatment and screening chamber that feeds wastewater to a moving bed biological reactor chamber (MBBR). Immediately downstream from the MBBR biorcactor is a secondary clarifier, which feeds a media polishing filtration system. The media polishing filtration system then passes the treated water to a UV disinfection system. The entire fully functional system, including the plastic vessel and control room, is self-contained in a military approved TRICON container. A Programmable Logic Controller (PLC) provides automated control of the system and monitors water levels, wastewater characteristics and system components. The container has access doors to the wastewater treatment control room.

WO Application No: 2004/009496 to Beine et al., discloses a portable/mobile wastewater treatment unit. The invention is directed to a portable/mobile biological treatment and water-recirculating apparatus for delivering activated microorganisms to an environment to be treated. The unit has at least one biological wastewater treatment unit, bioreactor nutrient pump, nitrification bioreactor unit and recirculating pump for circulating the wastewater to be treated and a controller to maintain the conditions of the bioreactors so as to maintain microorganism growth.

U.S. Pat. No. 10,053,384 to Robertson et al., discloses a system and process for removing nitrogen compounds and odors from wastewater and wastewater treatment system. The wastewater treatment system includes a wastewater collection system, at least one aeration subsystem aerating the aerobic portion, and at least one filtration subsystem. The wastewater collection system has an anoxic portion, an aerobic portion downstream of the anoxic portion, an anaerobic portion downstream of the aerobic portion. The filtration subsystem includes at least one bioreacting filter receiving fluid from the aerobic portion, being operable to filter wastewater received from the aerobic portion, and discharging filtered fluid into the anoxic portion, an oxygen contactor fluidically connected between the aerobic portion and the at least one bioreacting filter and operable to diffuse oxygen into the fluid being supplied from the aerobic portion, and an oxygen supply operable to supply oxygen to the oxygen contactor.

U.S. Pat. No. 8,529,770 to Yencho, discloses a self-contained UV-C purification system. The portable UV-C purification system is provided that includes a current reduction technique for an electric pump to reduce power demands on an associated generator to thereby produce a light weight and efficient system.

U.S. Pat. No. 8,871,089 to Early et al., discloses a wastewater treatment system. The wastewater treatment system includes a hollow, elongate, horizontally disposed, cylindrical body made from plastic is adapted for water storage and treatment. The cylindrical body includes reinforcement ribs formed by a helically wound steel band embedded in the plastic and extending between opposite open ends of the elongate cylindrical body. A voltage source selectively energizes the steel band. A pair of bulkhead members respectively extends across and covers opposite ends of the cylindrical body. A fluid-tight wall is mounted in the cylindrical body, the first bulkhead member, the fluid-tight wall and the cylindrical body forming a fluid-tight tank defining a liquid storage chamber. The second bulkhead member and the fluid-tight wall define a dry liquid treatment equipment chamber. An inlet pipe extends into the tank for admitting the pretreatment liquid into the tank. An outlet pipe extends from the tank and discharges the treated liquid from the tank.

All documents cited herein are incorporated by reference.

None of the above cited documents, alone or in combination, satisfy the need for portable insulated water treatment modules that are relatively small in size but have a relatively high flow capacity that addresses the above-mentioned deficiencies.

This background information is provided to reveal information believed by the applicant to be of possible relevance. No admission is necessarily intended, nor should be construed, that any of the preceding information constitutes prior art or forms part of the general common knowledge in the relevant art.

### BRIEF SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

It is an object of the invention to provide portable insulated water treatment modules and systems for purifying water.

In accordance with an aspect of the invention there is provided portable water treatment system, said system comprising: one or more modules, each module defining an interior space having one or more inlet ports and one or more outlet ports; a combination of one or more pieces water treatment equipment installed within the interior space of the one or more modules, each of the one or more pieces of water treatment equipment being selected and configured to perform a specific water treatment task; a series of exterior piping connecting the one or more modules, via the inlet and outlet ports, to a supply of water; a control panel operatively linked to the water treatment equipment in one or more of the one or more modules; and a control system operatively linked to one or more of the one or more control panels functioning to operate the one or more modules as a full integrated plant.

In accordance with an additional aspect of the invention there is provided portable insulated water treatment module, said module comprising: a rigid plastic container having outer walls, a base and a lid, defining an interior space; one or more inlet ports and one or more outlet ports extending through said outer walls; a combination of one or more pieces water treatment equipment installed within the interior space of the module; a series of interior piping connecting the one or more pieces water treatment equipment to the inlet and outlet ports; a series of exterior piping connecting the module, via the inlet and outlet ports, to a supply of water; and a control panel operatively linked to the water treatment equipment in the module.

In accordance with an additional aspect of the invention there is provided a water treatment system comprising: one or more portable modules, each module having an enclosed interior space defined by a base, walls and a top or lid, said interior space housing water treatment components piped and wired together, said water treatment components secured to said base, walls and top in positions that render them accessible for external service and operation through one or more side access ports or top access ports, said one or more portable modules having one or more process ports for conveying process streams into and/or out of the one or more modules.

The advantages and features of the present invention will become better understood with reference to the following more detailed description and claims taken in conjunction with the accompanying drawings.

### BRIEF DESCRIPTION OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIG. 1A illustrates a perspective aspect of a modular unit in accordance with one embodiment.

FIG. 1B illustrates a perspective aspect of a modular unit in accordance with one embodiment.

FIG. 1C illustrates a perspective aspect of a modular unit in accordance with one embodiment.

FIG. 2 illustrates a rear perspective aspect of a pumping modular unit in accordance with one embodiment.

FIG. 3 illustrates a cross sectional side aspect of a pumping modular unit in accordance with one embodiment.

FIG. 4 illustrates a perspective aspect of a chemical storage tank module in accordance with one embodiment.

FIG. 5A illustrates a perspective aspect of the outside of a chemical dosing module in accordance with one embodiment.

FIG. 5B illustrates a perspective aspect of the outside of a chemical dosing module in accordance with one embodiment.

FIG. 6 illustrates a perspective aspect of a chemical dosing module in accordance with one embodiment.

FIG. 6B illustrates a perspective aspect of an alternate chemical dosing module in accordance with one embodiment.

FIG. 7 illustrates a cross sectional aspect of a dosing module in accordance with one embodiment.

FIG. 8A illustrates a distribution panel mounted on a chemical dosing module in accordance with one embodiment.

FIG. 8B illustrates a control panel mounted on a chemical dosing module in accordance with one embodiment.

FIG. 9A illustrates a run enable contact controlled by the control panel in a chemical dosing module in accordance with one embodiment.

FIG. 9B illustrates a pressure drop versus flow curve for the inline process static mixer installed in the chemical dosing module in accordance with one embodiment.

FIG. 10A illustrates a field wired level switch that can plug into the control panel on a chemical dosing module in accordance with one embodiment.

FIG. 10B illustrates a top access removable static mixer installed in a chemical dosing module in accordance with one embodiment.

FIG. 10C illustrates a pressure switch installed in a chemical dosing module in accordance with one embodiment.

FIG. 11A illustrates a pH sensor installed in a chemical dosing module in accordance with one embodiment.

FIG. 11B illustrates a pH controller and transmitted installed in a chemical dosing module in accordance with one embodiment.

FIG. 11C illustrates a chemical dosing pump installed in a chemical dosing module in accordance with one embodiment.

FIG. 12A illustrates a low chemical level switch for installation in a remote tank that will plug into a chemical dosing module in accordance with one embodiment.

FIG. 13 illustrates a removable chemical dosing pump support bracket to be installed in a chemical dosing module in accordance with one embodiment.

FIG. 14A illustrates a double gang duplex plug box mounted below the control panel on a chemical dosing module where the power to the plug box is controlled by the control panel in accordance with one embodiment.

FIG. 14B illustrates a remote rental tank commonly available on the market that can be converted into a mixed reaction tank for use with a chemical dosing module in accordance with one embodiment.

FIG. 14C illustrates a drop in submersible mixer that can drop in the top of an open tank in accordance with one embodiment.

FIG. 14D illustrates a side access submersible mixer that can be installed through the side access of a tank in accordance with one embodiment.

FIG. 14E illustrates a top mounting submersible mixer that can be mounted on the top rail of a tank in accordance with one embodiment.

FIG. 15 illustrates a method of setting up a chemical dosing module to achieve a maximum flow rate in accordance with one embodiment.

FIG. 16 illustrates a method of setting up a chemical dosing module to achieve a maximum mixing time in accordance with one embodiment.

FIG. 17 illustrates an alternate method of setting up a chemical dosing module in accordance with one embodiment.

FIG. 18 illustrates a filter module in accordance with one embodiment.

FIG. 19 illustrates a side view of a filtering module in accordance with one embodiment.

FIG. 20 illustrates parallel connection of filtering modules in accordance with one embodiment.

FIG. 21 illustrates a pumping tank module in accordance with one embodiment.

FIG. 22 illustrates a set of four pumping tank modules installed in parallel in accordance with one embodiment.

FIG. 23A illustrates a valving module in accordance with one embodiment.

FIG. 23B illustrates a set of three valving modules installed in parallel with depth media filters in accordance with one embodiment.

FIG. 24A illustrates a process flow diagram for a valving module in filtering mode in accordance with one embodiment.

FIG. 24B illustrates a process flow diagram for a valving module backwashing filter A with feed water in accordance with one embodiment.

FIG. 24C illustrates a process flow diagram for a valving module rinsing filter A in accordance with one embodiment.

FIG. 24D illustrates a process flow diagram for a valving module backwashing filter B with feed water in accordance with one embodiment.

FIG. 24E illustrates a process flow diagram for a valving module rinsing filter B in accordance with one embodiment.

FIG. 25 illustrates a process flow diagram for a set of three valving modules installed and operating in parallel while backwashing Filter A and then Backwashing Filter B with filtered water produced from adjacent modules in accordance with one embodiment.

FIG. 26 illustrates a sludge extraction module in accordance with one embodiment.

FIG. 27 illustrates a process flow diagram of an example 1000 usgpm water treatment process for treating suspended solids and heavy metals in a mining application in accordance with one embodiment.

FIG. 28 illustrates a process flow diagram with ethernet communication links set up between the control systems of each treatment module in accordance with one embodiment.

FIG. 29A illustrates a perspective view of the layout of a base treatment plant with expanded treatment stages.

FIG. 29B illustrates an alternative perspective view of the layout of a base treatment plant.

FIG. 30A illustrates a perspective view of the layout of a base treatment plant with expanded treatment stages.

FIG. 30B illustrates an alternative perspective view of the layout of a base treatment plant with expanded treatment stages.

FIG. 31 illustrates a process flow diagram with expanded treatment stages.

FIG. 32A illustrates a perspective view of a clarifier with sludge thickening.

FIG. 32B illustrates an alternative perspective view of a clarifier with sludge thickening.

FIG. 33 illustrates a perspective view of the layout of an 800 usgpm TSS and metals treatment process.

FIG. 34 illustrates a plan view layout of a well head pumping module.

FIG. 35 illustrates a cross section view of a well head pumping module.

FIG. 36 illustrates six treatment modules piped in parallel.

FIG. 37 illustrates a cross section of a module.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

### DETAILED DESCRIPTION

The mobile water treatment modules are integrated and automated environmental treatment building blocks, that can be interconnected mechanically and electronically and connected externally to commonly available components including tanks, clarifiers, and vessels to form quick to deploy, automated and customized environmental treatment solutions housed inside compact, easy to deploy, insulated plastic boxes that have been modified to form an integrated environmental equipment enclosure.

The present invention relates to environmental treatment systems particularly for short term applications, rapid deployment and temporarily installations, intended for treatment of contaminated air, soil vapor, water, industrial wastewater, municipal wastewater and/or groundwater impacted with petroleum hydrocarbons, volatile organic compounds, BOD, nutrients, organic compounds, polycyclic aromatic hydrocarbons, metals, chlorinated solvents, radionuclides and/or suspended solids.

The mobile water treatment modules provide an innovative solution to overcome the cost, schedule and delivery challenges of a custom treatment system. The mobile water treatment modules can leverage the existing, readily available, subcomponents available through rental supply market and provide additional functionality and treatment complexity beyond what is available for temporary systems currently.

The water treatment modules are manufactured with the integration subcomponents housed inside pre-manufactured plastic insulated boxes. For example, boxes that are primarily used for storing and handling fish and other agricultural products (fish boxes) are ideally suitable. Fish boxes have been used in many other applications including providing secure packaging for shipping valuable products like race car engine subcomponents and providing water tanks for storing and transporting live fish as well as sump tanks for collecting and pumping fluids with an internal submersible pump. Utilizing fish boxes as the equipment enclosure for mobile water treatment modules is a key component to this innovation and has not been identified and implemented in this manner before.

The fish boxes have the following benefits when repurposed for this function.
1. Economical premanufactured insulated enclosure that can be purchased at a fraction of the cost of engineering and manufacturing a custom enclosure.
2. Watertight design allows for the bottom of the fish box to be utilized as a spill containment and collection sump with a warning alarm to notify the operator of a leak in the treatment module.
3. Engineered and designed to handle and transport 1000 kg of water which is strong enough to house the heaviest integration subcomponents that would be housed inside the treatment modules.
4. The fish box includes built in fork pockets for mobility to allow for easy lifting, transporting and placement on site with standard fork trucks and telehandlers.
5. Modules can be stacked to reduce shipping footprint and can be shipped via common LTL carriers across North America, which greatly reduces shipping costs compared to shipping a 40′ ISO container on a dedicated flatbed truck.
6. Compact light weight plastic design allows the treatment modules to be shipped by air if needed to remote locations and can be shipped by helicopter for rapid deployment applications.
7. The fish box dimensions are intended to allow the inside of the box to be reached for cleaning, this feature allows a water treatment operator access to the equipment easily for operating and maintenance and repairing from outside the module.
8. The box comes with a sealed lid that can be locked down for security and removed for maintenance access as required. The lightweight plastic insulated lid is light enough that a single operator can lift and remove the lid by hand.

To convert a fish box into a mobile treatment module a compact heating and ventilation system is built into the design as well as task lighting. Due to the compact nature of the module these HVAC subsystems are far more economical than HVAC systems required in the larger ISO container systems and premanufactured building-based systems.

The modules can be configured in a wide range of formats and house the key integration subcomponents including valves, pumps, piping, filters, actuators, transmitters, control switches, mixers, small tanks, and other sensitive equipment that requires integration to provide a fully operational and automated treatment system. The industry standard larger components required for the treatment process including tanks, clarifiers, media filters, membrane skids are shipped loose external to the treatment modules and connected to the treatment modules on site to form the integrated system. These components including the interconnecting piping can be heat traced and insulated separately in cold weather applications.

As an example, a typically designed water treatment system suitable for 150 gpm of treatment hydrocarbons would be custom built and assembled inside a 40 ft high cube shipping container. The container would house tanks, a control system, pumps, bag filter housings, media filter vessels. This 150 gpm hydrocarbon system can be achieved now with a mobile water treatment module. The key integrations components will be housed inside one treatment module with the approximately dimensions of 4′×4′×4′ and would be assembled and tested turnkey with the control system, controls and power distribution. The module would house the pump, filter housings, flow meter, valves, instrumentation. The module would be set up next to external tanks, and media filters. In this example the cost and time to manufacture and the cost to ship and handle the mobile water treatment module is far less than the conventional approach.

The mobile treatment modules can be designed as building blocks that can be assembled together in parallel and series to form larger more complex water treatment processes for site specific applications. Mobile treatment modules can be customized for project specific requirements and for client preferred features. The treatment modules typically used as building blocks include, but are not limited to, pumping modules, chemical dosing modules, chemical storage tank modules, sludge wasting modules, valve modules, pumping tank modules, filtering modules, and well head enclosure modules.

The attached figures show various examples of embodiments of some of the standard treatment modules. Although the objective is to standardize module designs, the exact configuration of the modules and selected integration components will vary depending on the types of treatment processes that are being set up and operated. Some clients may request additional or different integration components for their modules which can be accommodated as requested by the client or as required on a project or application.

Where suitable the modules are designed with dual ports mirrored on each side of the module in matching locations so identical modules can be quickly connected together in parallel side by side to expand to match the flow requirements on the site reducing the site piping required. These ports could include inlet ports and outlet ports, backwash feed ports, backwash waste ports, drain ports. Examples of this feature are shown where additional sets of filtering modules, are connected to one another for an expanded flow capacity as we; as additional sets of valving modules connected together and additional sets of pumping tank modules are connected to one another for an expanded flow capacity.

By having the standard treatment modules fixed and pre-designed the key subcomponents with long delivery schedules can be kept in inventory and the integrated modules can be manufactured quickly to meet the demanding schedules on new temporary mobile water treatment projects.

The treatment modules are manufactured with external mounted control panels to allow the integration components to be pre-wired, tested and controlled by the individual control panels. Each mobile treatment module that houses automation equipment can be equipped with a control panel with dedicated self-contained controllers capable of automating and controlling the integrated subcomponents within the mobile treatment module as a standalone smaller system. Each treatment module can then be connected to the upstream and downstream treatment modules via ethernet cables or wireless access points were running ethernet cables is prohibitive. This network allows the self-controlled treatment modules to be connected upstream and downstream in the treatment process to start, stop, shutdown and pause water flow as required between modules to maintain an automated and integrated treatment process.

Each mobile treatment module can run independently and can integrate with other treatment modules quickly and easily to form a customized treatment process when connected on a common ethernet network. Typically, a custom water treatment system with multiple panels would require one main panel with a master PLC. Remote IO would then be utilized at the other panels operating on a network. This technique requires the whole control system to be custom designed, programmed and wired up for the one application only. This is time consuming and requires extensive factory and field testing to confirm the logic and alarms are all working correctly for each installation. This novel modular control method developed for the mobile treatment modules is a major advancement from the conventional method of controlling a customized water treatment plant and allows for flexibility and quick integration of self-contained treatment modules to form larger more complicated customized water treatment processes.

This modular control method enables clients to acquire a rental fleet of mobile treatment modules that can be deployed in various configurations to match project specific requirements. Once the modules selected for a project are connected together in a network, the operator can quickly and easily configure the modules chosen for the project by choosing static IP addresses for each controller, as well as defining the IP addresses of the upstream and downstream controllers that are configured in a daisy chain. The operator can also define the IP addresses of the remote controllers on the network located in other upstream and downstream mobile treatment modules that provide remote pause enable signals. This modular control functionality enables the operator with the ability to quickly configure a fully integrated custom treatment process using many prebuilt and pretested mobile treatment modules connected together.

Additional examples show how a client with a fleet of rental mobile treatment modules could quickly and easily configure the modules readily available in the fleet to form a large, complex, customized 1000 usgpm metals treatment process for treating mine tailings water.

Further figures show how these modules could then be connected in a daisy chain network using the modular control method for communication between modules to provide a fully integrated and automated treatment process.

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

The term “connected”, “attached”, “affixed” or “coupled to” may include both direct coupling (in which two elements that are coupled to each other contact each other) and indirect coupling (in which at least one additional clement is located between the two elements).

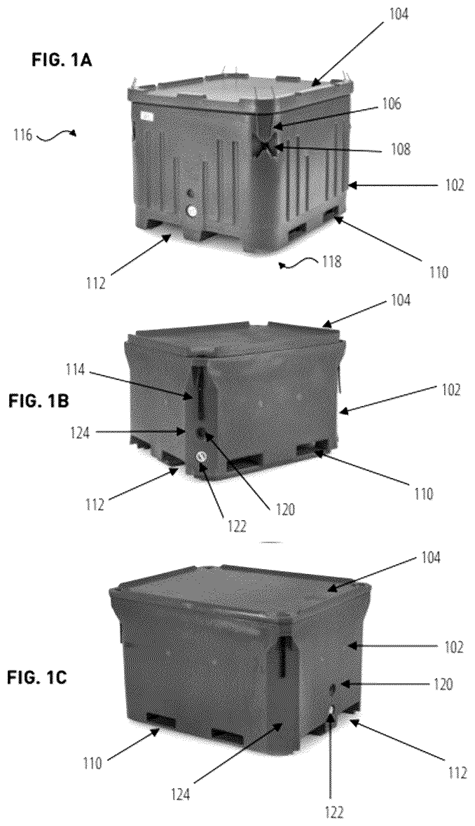

FIG. 1A shows a perspective of a portable insulated module 116 before modification to use as a mobile water treatment module.

The portable insulated module 116 shown in this embodiment is essentially a square cube having plastic insulated side walls 102 and a plastic insulated lid 104. The lid 104 being securely fixed one or more side walls 102 via a lid securing tie 106 in cooperation with a lid securing mechanism 108. The lid securing mechanism 108 may be a structure on the lid 104 and the lid securing tie 106 may be looped or hooked mechanisms attached to one or more side walls 102 that cooperate with the lid securing mechanism 108. Conversely, the lid securing tie 106 may be a structure on the lid 104 and the lid securing mechanism 108 may be a structure on one or more side walls 102 that cooperate with the lid securing tic 106.

Typically, the base 118 of the portable insulated module 116 is configured to be lifted by a forklift truck. The base 118 comprising pairs of fork pockets 110 and/or fork indents 112.

FIG. 1B shows a front perspective of an alternative portable insulated module 116 before modification to use as a mobile water treatment module.

The portable insulated module 116 shown in this embodiment is a rectangular cube having plastic insulated side walls 102 and a plastic insulated lid 104. The lid 104 being securely fixed one or more side walls 102 via an alternative lid securing mechanism 114.

Again, the base 118 of the portable insulated module 116 is configured to be lifted by a forklift truck. The base 118 comprising pairs of fork pockets 110 and/or fork indents 112.

The portable insulated module 116 may have a water outlet port 122 preformed through one of the side walls 102 of the portable insulated module 116. A water inlet port 120 may be bored through an indent formed on one of the corners 124.

FIG. 1C shows a rear perspective of the alternative portable insulated module 116 illustrated in FIG. 1B before modification to use as a mobile water treatment module.

The portable insulated module 116 may have a water outlet port 122 preformed through one of the side walls 102 of the portable insulated module 116. A water inlet port 120 may be bored through an indent formed on one of the side walls 102.

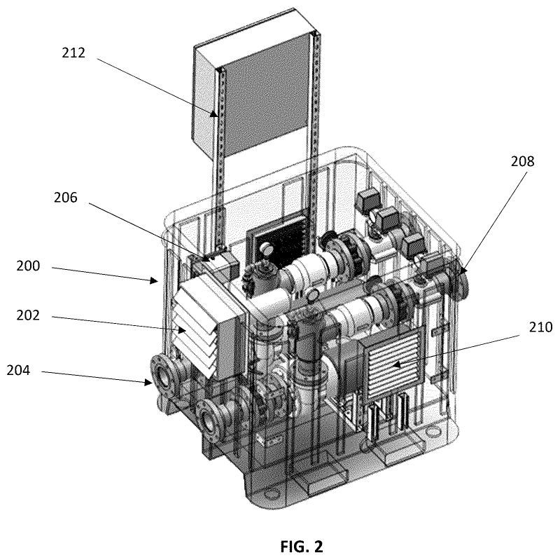

FIG. 2 shows a rear perspective aspect of a pumping modular unit.

This figure shows an example of one embodiment of a pumping module 200 where two pumps are installed suitable for operation at 350 gpm each. In this configuration 500 gpm close coupled pumps can also be installed for higher flow applications. Pumps can be piped easily in parallel for higher flow or series for higher pressure. Pumps can also be piped to serve different purposes in a treatment process. As an example, one pump could be piped to feed a chemical dosing module and the second pump could then be used to pump water from the outlet of a clarifier into a filtering module. Ventilation fan 202 and louvers 210 are installed in the walls of the module to manage heat buildup during operation, heater 206 is installed in the interior wall of the module for operations under cold climate. Process Inlet port 204 is shown in this view and Process Outlet port 208 is installed at the opposite end of the module. Control panel 212 is mounted on the module to control the pump and communicate with panels on other treatment modules.

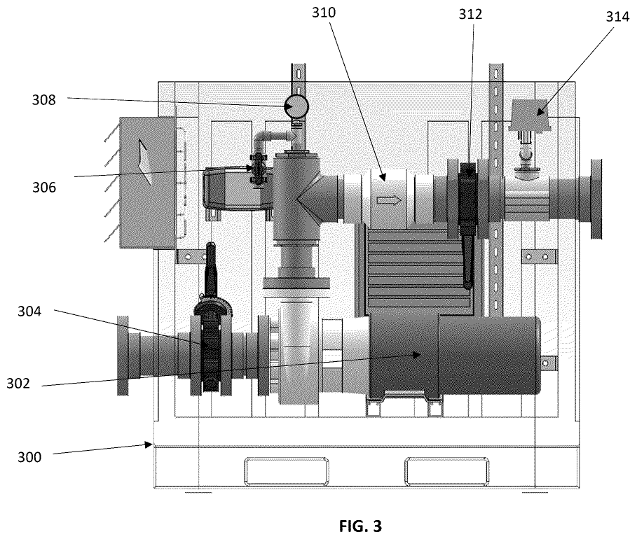

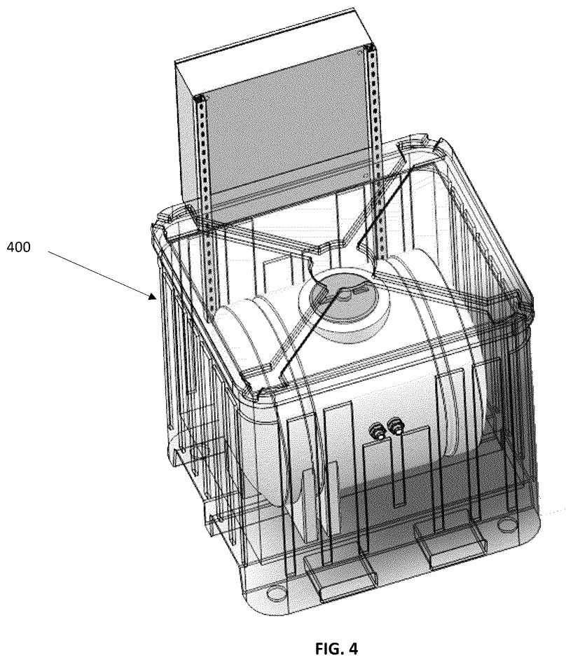

FIG. 3 shows a cross section side view of the pumping modular unit.

The pumping module 300 shown in this view has pumps 302 installed at the bottom of the module supported by strut which is bolted to the side wall as shown in FIG. 2. Butterfly valves 304 and 312 are installed upstream and downstream of the pump respectively to control the fluid flowrate entering the pump and allow the pump to be isolated from the process to perform maintenance. Ball valve 306 and pressure gauge 308 are installed above the pump to monitor pressure. Check valve 310 is installed downstream of the pump to prevent reverse flow, Butterfly Valve 312 is used to control outlet flow rate and pressure switch 314 is mounted on a pipe saddle clamp and attached downstream of the outlet butterfly valve to monitor outlet pressure and enable alarms through the automated pump control panel.

FIG. 4 shows a rear perspective of the chemical storage tank module 400.

The chemical storage tank is mounted inside the portable insulated module. The module provides secondary containment for chemical storage. Although it is not shown in the figure, the module can be built with interior heat trace to keep the storage tank warm, and a level switch is installed inside the module to detect a leak in the chemical tank similar to other treatment modules.

### Example 1

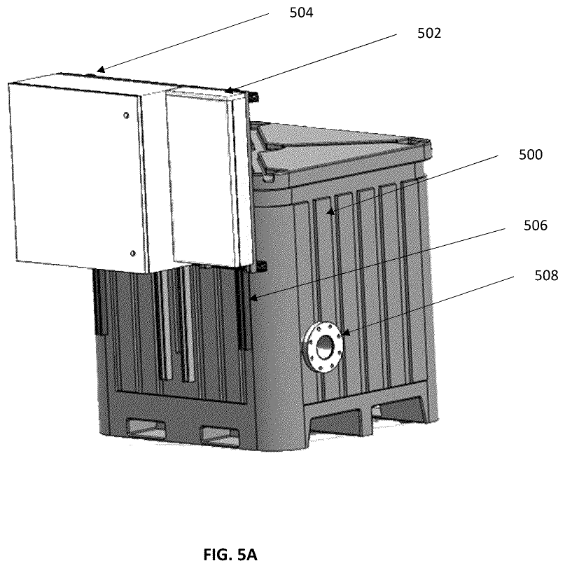

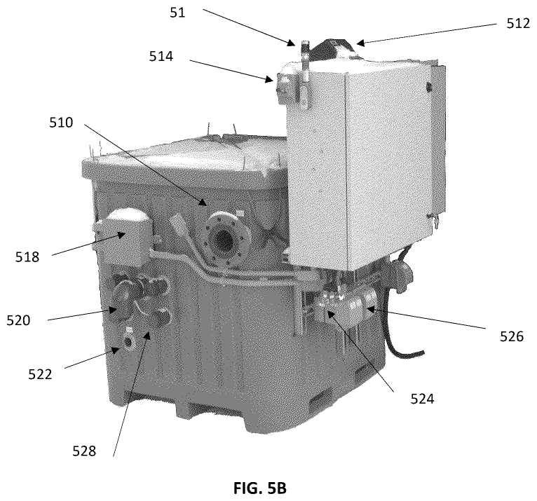

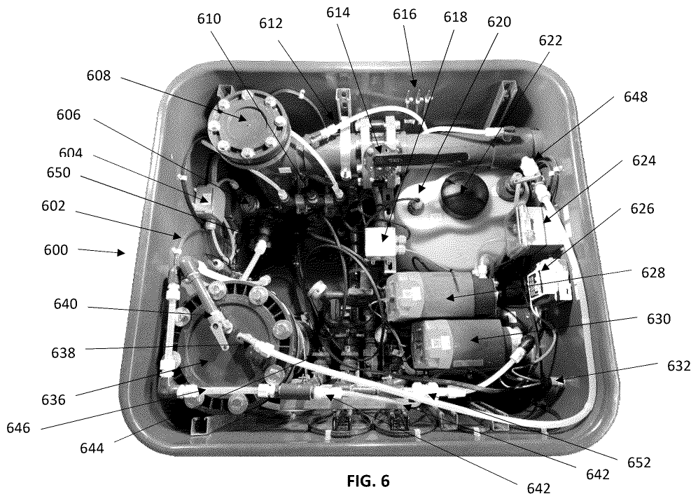

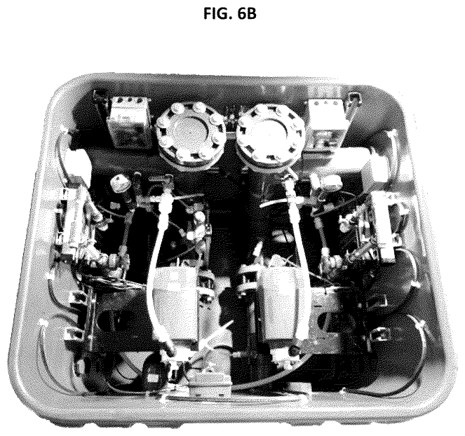

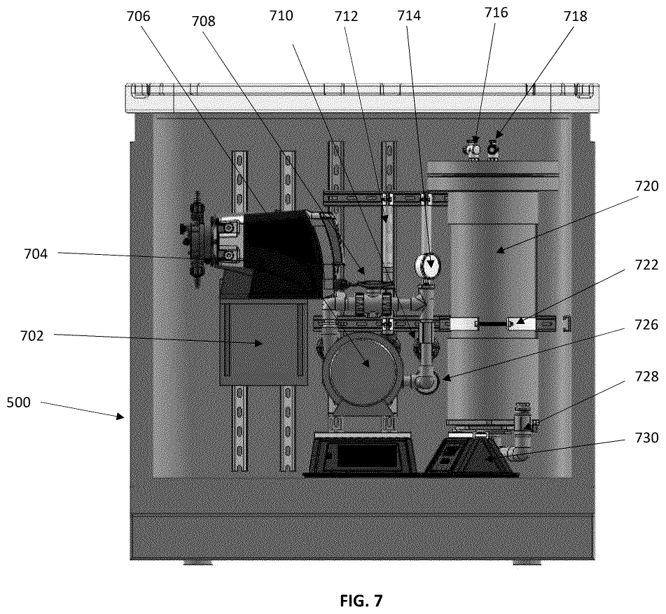

FIG. 5A, 5B, FIG. 6, 6B and FIG. 7 all illustrate chemical dosing modules.

FIG. 5A shows an exterior isometric view of a chemical dosing module.

Isometric view of one embodiment of a chemical dosing module with the integrated treatment equipment as well as a small inline ventilation fan and heat tracing for interior heating.

The portable insulated dosing module 500 has a power distribution panel 502 mounted on the side for distributing power to necessary devices and is mounted adjacent to the control panel 504 which houses various automated controls components including PLCs, relays, terminal strips and contactors to enable automation of the treatment module. Strut 506 is mounted on the side wall of the module for supporting the control and power distribution equipment. The process feed water port 508 is shown on the side of the module.

FIG. 5B shows a second exterior isometric view of the chemical dosing module.

The portable insulated dosing module 500 shown in this view has a process feed water outlet 510 on the side of the module. Exterior light 512 is installed on the back of the panel with a light switch 514 installed on the side of the panel and is situated to illuminate the inside of the portable insulated dosing module 500 for serviceability. A 3-level signal tower stack light 516 is mounted on top of the panel to provide operation status of the module with system operational in green, warning alarm in yellow, and system alarm in red. This feature is useful when operating a large process with many modules as it allows the operator to quickly see which module has an alarm condition. Electrical junction box 518 is mounted on the side of the module housing terminal strips and connectors for wiring electrical components within the insulated enclosure back to the control panel. Ventilation port 520 is installed on the side of the module to allow cooling air into the module 500 and to draw hot air out of the interior of the module. Overflow drain port 522 is mounted the bottom side of the module to allow excess water to overflow out of the module 500 rather than flooding the module causing damage to the equipment. Quick connect electrical fittings 524 are installed below the panel, these fittings are used to connect field mounted electrical instrumentation and equipment including float switches, contact switches, and powered devices. Duplex receptacle boxes 526 are mounted below the panel and the power is controlled by the automated control panel 504. Field mounted devices including submersible mixers can be plugged in and operate automatically with the control system. Chemical Tube ports 528 are mounted on the side of the module. These fittings are oversized to allow a hose connection on the fitting so the chemical tubes can be fed through the center of the fitting and convey to the desired location within a flexible hose providing secondary containment for chemical and allowing heat trace to run inside the secondary containment hose to keep the chemical lines warm in cold weather operation.

FIG. 6 shows an open top view of a dosing module.

The interior of the portable insulated dosing module 600 shown in this view has heat trace 602 installed on the inner wall of the module to maintain consistent temperature within the portable insulated module. Proof of flow pressure switch 604 is mounted on the inner wall of the module to detect the water pressure entering the static mixer 608, the pressure is measured using the pressure gauge 606 installed on the feedline. pH port 610 is installed inside the module allowing a pH probe mount on top to monitor the pH of the feed water, the pH sample is taken from the pH line 612 installed downstream of the static mixer and can be open or close using the valve. Static mixer flow control valve 614 is installed downstream of the static mixer to control the flowrate through the static mixer. Temperature sensors 616 are installed at the inner wall of the module to monitor the interior temperature, these sensors are connected to the temperature switch inside the control panel to control the temperature inside the dosing module 600 and provide warning alarms. A small electrical box 618 is installed in the middle of the module supported by structs housing wiring for the level switch assembly 620 which monitors the polymer level inside the polymer tank 622. Duplex receptacle box is mounted on the inner wall of the modules to allow electrical components within the portable insulation module to be plugged int and receive power. A Duclometer pH controller and transmitter 626 is mounted on the inner wall beside the receptacle box and plugged to monitor the pH through a pH probe 610 and control the chemical pump 630 based on the pH readings. Chemical pumps 628 and 630 inside the module are supported by a removable plastic mounting bracket attached to struts bolted into the inner wall of the module, these pumps are plugged into the receptacle box inside the module to receive signals from the panel and duclometer for chemical dosing into the feedline. Wiring port 632 is installed at the inner wall of the module where electrical wirings are fed through the strain relief and enters the junction box mounted at the outer wall of the module. Polymer dosing pump 628 transfers raw polymer from the polymer storage tank 622 within the module through a raw polymer transfer hose 642 and is injected into the polymer makedown line through an injection quil 642. A polymer makedown water flow control valve 644 is adjustable to set the ratio of supply water to the raw polymer flow. The raw polymer is mixed with the make down water in the polymer static mixer 646 and is fed to the bottom of the blending unit 636. The blending unit provides residence time for the polymer to age. The blended polymer is transported up and exits the polymer blending unit 636 through the polymer blending unit outlet 638 and enters the process line downstream of the process static mixer 608 through a blended polymer injection valve 648. An alternative blended polymer discharge line 640 is installed on top of the blender unit to allow blended polymer to be injected to the process static mixer inlet chemical injection valve 650. In this module the blended polymer can also be directed through a chemical tube port 528 to inject blended polymer directly into an external process tank where submersible mixers are installed and plugged into the duplex receptacle boxes 526.

A coagulant dosing pump 630 is also installed on the removable pump bracket and will draw coagulant into the module from an external tank through a chemical tube port 528. The chemical can be dosed directly from the into the process static mixer inlet chemical injection valve 650 or it can be injected into a coagulant makedown line through the coagulant makedown line chemical injection valve 652. The blended coagulant can then be injected directly into the process static mixer inlet chemical injection valve 652 or the diluted chemical mixture can be transferred through a chemical tube port 528 and conveyed to an external static mixer or external mixed reaction tank for injection. By having flexibility in the injection locations for coagulant and flocculant the chemical dosing module can be deployed in different configurations depending on the individual project needs.

FIG. 7 shows a side cross sectional view of a dosing module.

The interior of the portable insulated dosing module 500 shown in this view has plastic removable mounting bracket 702 bolted onto the struts at the wall to support the chemical pumps 704 attached above. This mounting bracket allows the operator to easily lift the pumps and bracket out of the module for servicing or to provide additional accessibility to service other components inside the module. Water feed pump 706 is installed at the bottom of the module and mounted on a pyramid base support 730 placed on the bottom of the interior box. This pyramid support is not bolted into the floor of the box to allow the interior floor to remain sealed and hold water in the event of a leak. Water feed pump 706 provides service water to the chemical injection lines and can be isolated using the isolation valve 708 installed above the feed pump. Check valve 726 and gate valve 710 are installed downstream of the water feed pump to control the flow of water into the individual flocculant and coagulant chemical makedown lines, rotameters 712 are installed above the gate valve 710 to measure and set the flow rate for diluting the chemical mixture. A pressure gauge 714 is installed on the outlet of the service water pump to measure the pressure of the service water line. Ball valves 716 and 718 are installed on top of the polymer blending unit 720 for determining which location the blended polymer will be injected into. The blending unit is secured by a clamp 722 installed on a horizontal strut bolted on the interior wall of the module and elevated by a pyramid base support 730 allowing polymer to enter from the bottom of the blending unit through the injection line 728.

The dosing and control module is a mobile water treatment module designed to operate as a standalone automated treatment process or it can be linked into a larger plant to operate within a much larger treatment process.

The primary objective of the dosing and control module is to condition a wastewater stream by dosing and mixing a coagulant and a flocculant to promote precipitation, coagulation, and flocculation of solids. The conditioned water would then flow to a downstream clarification process where the solids would settle or float out of solution depending on the application. The dosing and control system includes feed pump controls, mixing controls for multiple submersible mixers, coagulant make down and dosing and flocculant make down and dosing and a process line static mixer.

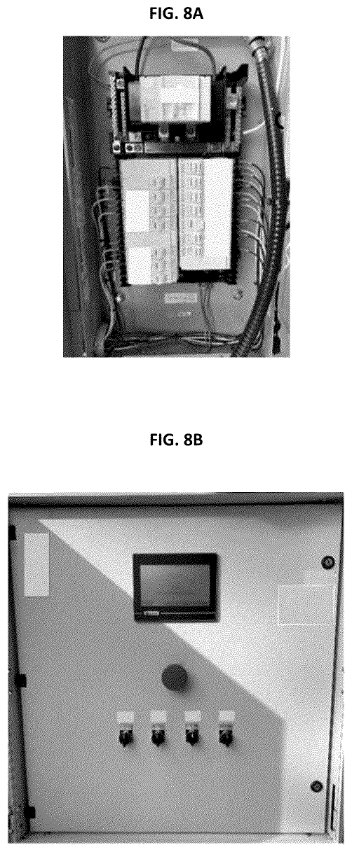

FIG. 8A shows a power distribution panel.

The power to the module is fed by a 125A, 240V/120V, Iph Nema 3R breaker panel. This panel distributes power to the various process equipment controlled by the treatment module and provides additional expansion slots for addition of field wired devices as required. FIG. 8B shows a main automated control panel.

The treatment module is controlled via an automated control panel. The panel is assembled with a dead front cover and an inner swing panel. The HOA switches and the HMI are mounted on the inner swing panel which allows the panel door to be closed and locked out when the operator is not present. An emergency stop button is mounted on the door that will disconnect power in both manual and automatic for all the automated output devices in the system.

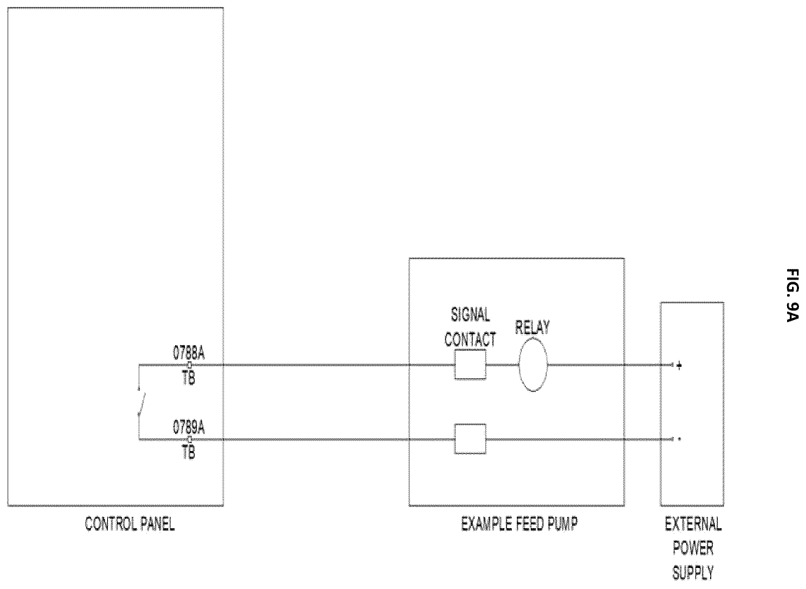

FIG. 9A shows the feed pump controls package.

The module is set up to control a set of dry contacts to be used to start and stop a feed pump supplied by others. The most common application for this feature is to use the dry contacts with the remote start/stop contacts on a diesel powered transfer pump.

This device is controlled via a hand/off/auto selector switch mounted on the inner swing panel. In manual the device will run as long as the Emergency stop button is not pressed, in Auto the device will run if the controller is providing the run signal.

This feature allows the treatment module to control the operation of an upstream feed pump in the process. The diagram below shows how these contacts should be wired in to the panel. The dry contact terminal strips in the panel are labeled 0788A and 0789A are shown in FIG. 9.

FIG. 9B shows a chart indicating pressure drop versus flow rate.

The ideal pressure drop for the mixing element is 4-15 psi and will vary depending on flow rate. The 5-stage mixing clement supplied with the system is intended for use in the flow rate of 50-200 gpm. For higher flow applications, the mixer can be removed and modified or replaced with lower pressure drop versions to reduce the total pressure drop at higher flow rates.

The chart illustrated in FIG. 9B provides a pressure drop versus flow rate across the mixer which can be used to predict pressure drop when selecting an upstream pump or for rudimentary flow measurement using pressure gauges upstream and downstream.

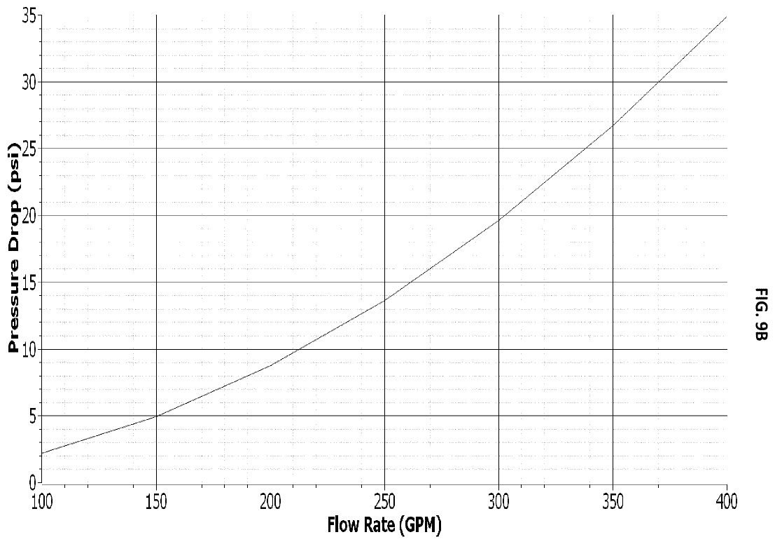

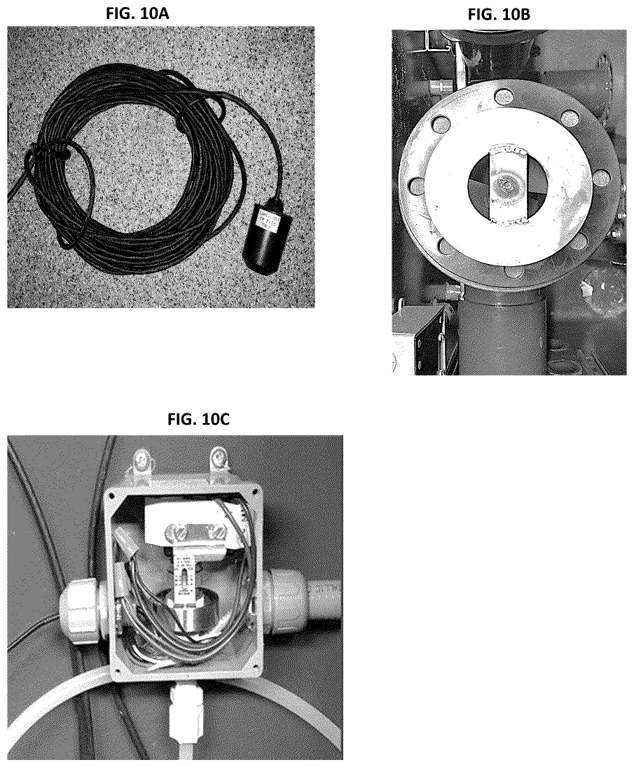

FIG. 10A shows a ball float switch.

Typically, three ball float level switches are supplied, each with 100′ of cable. One switch is a high pump start switch, the second is a low pump stop switch and the third is a high shutdown switch that is to be installed in the downstream tank to stop the feed pump if required to prevent flooding downstream. The switches are supplied with pre-wired quick connect fittings to allow the operator to easily connect the switches into the panel on site. Both sides of the quick connect are labeled to match up to ensure the correct switch is installed in the correct location. Some switches are normally open and others are normally closed so it is important that the correct switch is installed in the correct location.

FIG. 10B shows an inline static mixer.

A 4″ inline static mixer is installed and mounted in the dosing and control module. The mixer is supplied with multiple mixing elements designed to provide static mixing of chemicals injected upstream.

The ideal pressure drop for the mixing element is 4-15 psi and will vary depending on flow rate. The 5-stage mixing element supplied with the system is intended for use in the flow rate of 50-200 gpm. For higher flow applications, the mixer can be removed and modified or replaced with lower pressure drop versions to reduce the total pressure drop at higher flow rates.

The mixer housing is built with a top access blind flange that can be removed to access the mixer if required. The orientation of the mixer inside the housing is important and care should be taken if removing and reinstalling the mixer to maintain the same orientation. The orientation of the mixer should be maintained so the pressure drop is reduced where the water exits the top of the mixer as shown in FIG. 10B.

FIG. 10C shows a proof of flow pressure switch.

A high pressure switch is installed in the module and piped into the feed line to the static mixer. When water flows through the static mixer, the pressure on the inlet is detected allowing the chemical dosing pumps to begin. If the water pressure is lost the dosing pumps will pause and wait for the pressure to return and an alarm will activate on the treatment module.

The factory setpoint for the switch is 5 psi, the setpoint range of the switch is 2-15 psi and can be adjusted in the field if needed to ensure it activates and deactivates properly. If, as an example, the process water leaving the DMA module is pumped up hill to a clarification tank, the static pressure in that line may be higher than the 5 psi factory setpoint causing the switch to be on all the time. In that case the switch should be adjusted on startup to accommodate the required setpoint for the application.

To adjust the setpoint remove the cover on the box to access the pressure switch. The round dial on the switch can be rotated counterclockwise when looking down on the electrical contacts to lower the pressure setpoint or rotated clockwise to raise the pressure setpoint.

Static Mixer Flow Control Valve, such as a 4″ butterfly valve, is installed downstream of the static mixer. This valve serves two purposes, first it provides the option to control flow through the static mixer to maintain a steady flow for chemical dosing. Chemical dosing process work best at a steady flow rate with as little stopping and starting as possible. It is best practice to set the downstream process flow rate higher than the chemical injection stream flow rate to ensure the chemical injection stream can run constantly. It is best to set the flow at this location at the design flow rate with the throttling valve.

The second purpose of this valve is to ensure there is sufficient pressure drop between the inlet and outlet sampling locations for drawing a slip stream of water for pH monitoring and control as described below.

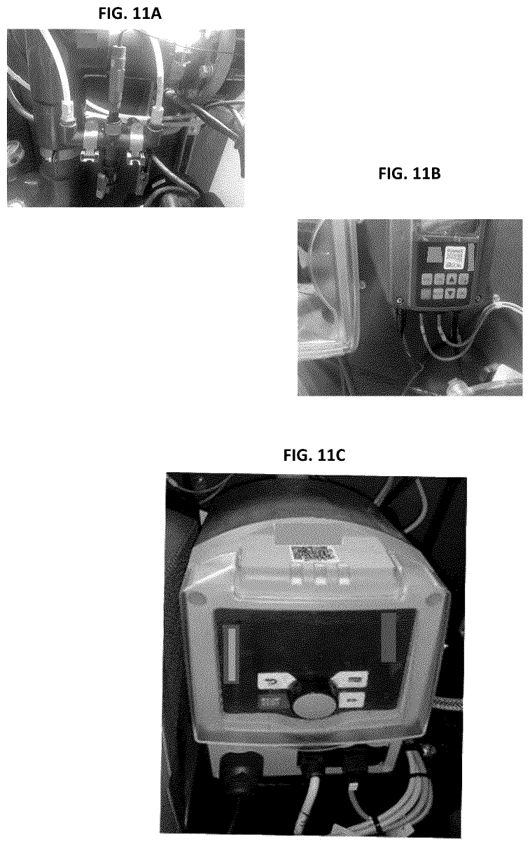

FIG. 11A shows a pH/ORP sensor.

This module is set up with a pH/ORP monitoring and controlling package (pHT-DMA1). Depending on the process and chemical being injected either a pH meter or an ORP meter can be installed in the assembly, plugged into and monitored by the pH/ORP controller and transmitter mounted in the enclosure. The pH/ORP sensor is threaded into the top side of a tee assembly mounted inside the equipment enclosure.

FIG. 11B shows the pH/ORP controller and transmitter.

The pH/ORP controller and transmitter serves four purposes:

Meter Display: The pH or ORP reading is displayed.

Alarm Monitoring: The meter is programmed to monitor the signal compared to an operator adjustable high and low limit setpoint and will trigger a limit alarm back to the control system to notify the operator if the signal drops out of range. This is configured as a warning alarm but not a system shutdown alarm in the control system.

Dosing Pump Speed Control: The pH/ORP controller and transmitter is set up to control the speed of the coagulant dosing pump CP1 to maintain a pH or ORP setpoint set up in the controller Proportional Integral Derivative control circuit.

Sensor Calibration: The pH or ORP sensors can be calibrated regularly using the controller and transmitter key pad.

Remote Tank Mount pH Sensor: In some cases it will be beneficial to monitor pH in a large external mixing tank with the coagulant dosing pump controlling the pH/ORP in that tank. In this case a Remote Tank Mount pH/ORP Sensor can clamp on the top of the remote tank and connect into the pH/ORP controller and transmitter.

The service water pump 706 is mounted inside the DMA module to provide clean water to the onboard chemical make-down systems. This is a 1 hp pump capable of delivering 10 gpm@48′ tdh or 5 gpm@50′ tdh. The primary purpose of this pump is to provide clean water (suspended solids<5ppm), to make down a dilute flocculant mixture for the flocculant dosing system. This service water can also be used to make down a dilute coagulant mixture to improve dosing performance and allow for transfer of dilute chemical to other locations on the site outside of the module.

If clean water is not available, water downstream of the clarification process may be used which may still contain some suspended solids. This water can still be used if needed knowing the solids will react with the flocculant in the make down system to create larger solids particulate. This particulate can accumulate in the mixers and polymer blender and aging tank and would then require flushing, disassembly and cleaning more frequently.

A low level switch is supplied with the chemical dosing module. It includes an adjustable tether weight to allow the cable to be suspended from the top of the tank. This switch should be installed in the tank where the service water pump is drawing water from.

FIG. 11C shows a coagulant dosing pump.

A chemical dosing diaphragm is mounted in the chemical dosing module for dosing chemicals into the first treatment stage. This pump is capable of a turn down ratio of up to 40,000:1 to give a very wide range of flow conditions.

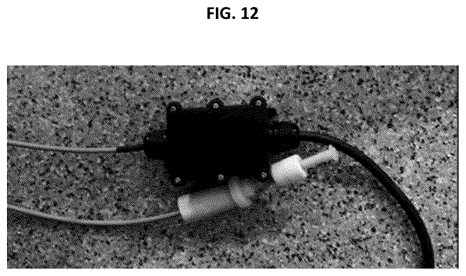

FIG. 12A shows a coagulant feed tank low level switch assembly.

The system is supplied with a loose shipped level switch for monitoring the chemical level in the chemical tank supplying chemicals to the chemical feed pump. This switch is supplied with a quick connect attachment on the panel end to connect into the panel. On the other end a junction box is provided so the switch wires can be disconnected in the field to be fed through a strain relief fitting in a coagulant tank, drum or tote provided separately.

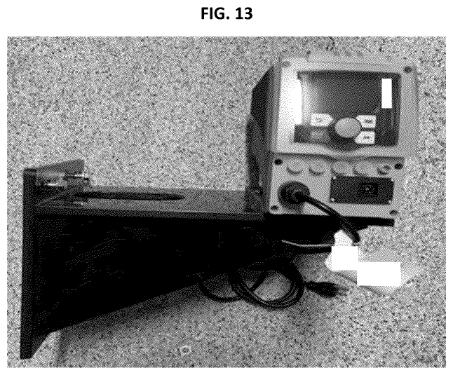

FIG. 13 shows a removable chemical pump mounting bracket.

The chemical pumps are mounted on a plastic mounting bracket. The bracket is designed to slide up and down on the Unistrut rail mounted to the side of the enclosure for easy removal of the pumps.

Coagulant Make Down and Mixing Package: The coagulant can be dosed into the process or can be mixed with service water and fed as a dilute chemical mixture. The dilute mixer provides some process advantages when used including:
Allows for running a dilute chemical in tubing on site outside of the enclosure.
The premixing dilution stage balances out chemical concentrations being fed to a static mixer in an inline application.
The flow rate of chemical delivered to the process is higher giving a quicker reaction time for pH and ORP control.

Service water is fed to the make down and mixing package through check valve and gate valve for flow control. A rotameter is installed in the line to measure and set flow rate for the dilute mixture. This flow is typically set at 1-8 liters per minute depending on the application. After injection the chemical is mixed through a static mixer and then fed to the process.

Injection Valve: The coagulant dosing package is included with an injection valve which is spring loaded and requires a minimum of 5 psi pressure to overcome the spring and inject chemical. This allows the chemical flow to shut off immediately when the pump stops leaving the chemical line pressurized and charged to inject immediately when the pump is turned back on.

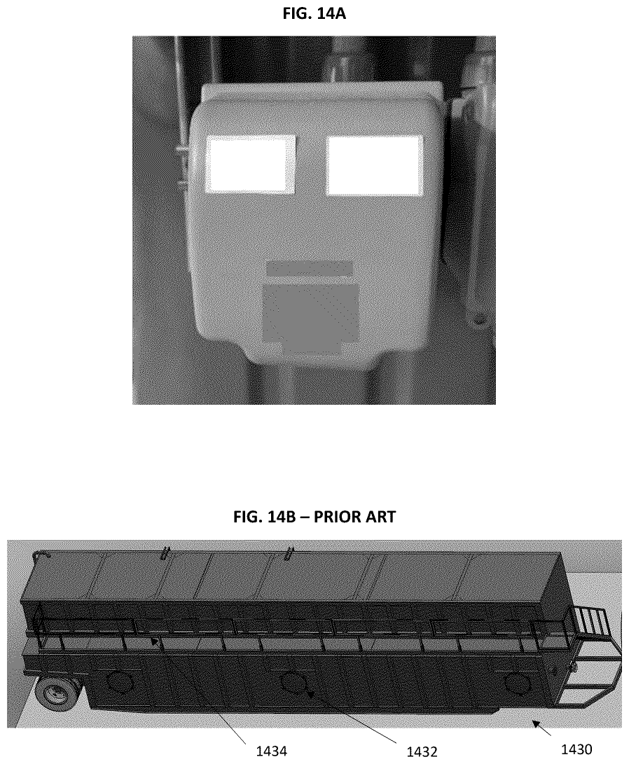

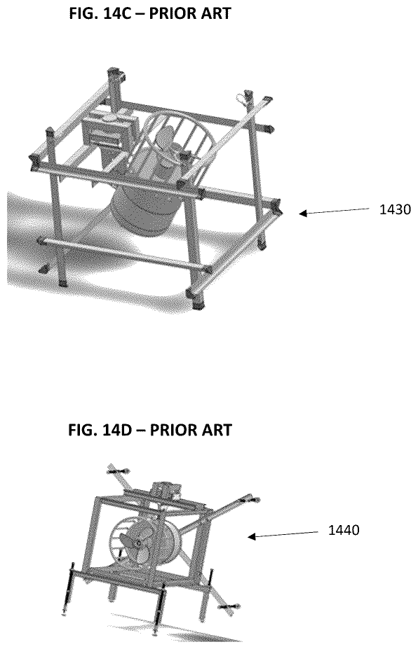

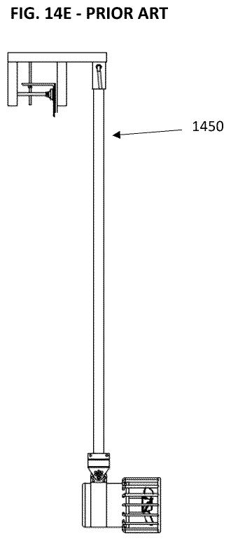

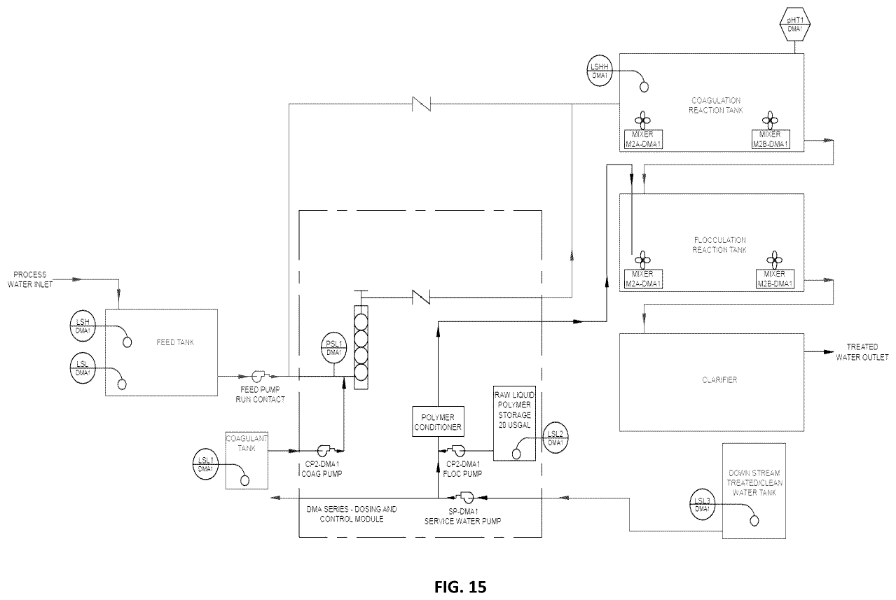

FIG. 14A shows a coagulant submersible mixer electrical outlet.

The power distribution and control panels are built with automation to control submersible tank mixers that are supplied separately and shipped loose. A duplex receptacle box is mounted below the control panel where the submersible mixer can be plugged in to and operate automatically with the control system.

These submersible mixers can be installed in external weir tanks and frac tanks for chemical mixing processes. When operating a chemical precipitation process, maintaining a steady mixed stream of influent parameters is very beneficial. One or both of these mixers can be installed in the inlet equalization tanks allowing the tanks to be blended and preventing solids from settling out in the tanks.

In another application, these mixers can be used in mixing tanks for coagulation, pH adjustment, oxidation, reduction, and adsorption processes.

This device is controlled via a hand/off/auto selector switch mounted on the inner swing panel. In manual the device will run as long as the Emergency stop button is not pressed, in Auto the device will run if the controller is providing the run signal.

FIG. 14B shows a typical water tank available for rent commonly called a frac tank 1430. This tank may have an open top or a closed top and could have weirs inside the tank or be an open tank. These tanks will have access hatches 1432 on the side of the tank to allow access to the inside of the tank. Some tanks have catwalks 1434 to allow easy access to service equipment installed inside the weir tank. This tank can be used as mixed reaction tanks when submersible mixers are set up inside the tanks and controlled by the electrical outlet shown in FIG. 14B. This tank can also be converted into a clarifier by inserting settling media in the section of the tank and withdrawing sludge from the bottom section of the tank below the media.

FIG. 14C shows a drop in submersible mixer 1430 that can be placed inside a rental water storage tank to mix the water and maintain solids in suspension. This submersible mixer can be placed in the top of an open top tank easily and will push up against the side wall of the tank allowing the mixer to remain in a fixed location when running.

FIG. 14D shows a side access submersible mixer 1440 that can fit through the side access hatches 1432 and be assembled inside the tank to operate inside closed top frac tanks 1430.

FIG. 14E shows a top mount submersible mixer 1450 that can clamp onto the top side beam of an open top frac tank or other open top rental tanks. This configuration works well as the operator can access the mixer from the catwalk.

A chemical dosing peristaltic pump is mounted in the chemical dosing module for dosing flocculant into the flocculant make down system. This pump is capable of flows from 6 ml/hr to 18 l/hr to give a very wide range of flow conditions.

The various features and functions of this pump as well as key operational notes are described below:

Start Stop Pump Control: The system is designed such that the pump can be started and stopped from the control panel directly on the face of the pump. If the pump is not required it can be left off or unplugged. It can be stopped by the operator by pressing the start/stop button. When stopped the solid square symbol is displayed in the top left corner of the pump screen. When the start button is pressed the hand symbol will flash with the stop symbol until the remote start signal is obtained at the pump from the controller.

Manual Fixed Speed Control-This pump is designed to be run at a manually set flow rate when the system is running. The control panel will send a run signal using the remote pause function on the pump when the pump is in manual. Refer to the manual on the chemical pump for control features.

Flocculant Make Down and Mixing Package: The flocculant used with this module is a liquid invert emulsion polymer. This polymer can be anionic, or cationic depending on the application. The flocculant dosing peristaltic pump doses a small flow rate of flocculant into a service water slip stream to generate a dilute polymer solution in the range of 0.1-0.5%. The flocculant is blended in a static mixer and then fed to a blending and aging tank where the flocculant has time to condition to allow for maximum flocculation performance. The flocculant stream then discharges from the top of the blender and into the dosing location.

Service water is fed to the make down and mixing package through check valve and gate valve for flow control. A rotameter is installed in the line to measure and set flow rate for the dilute mixture. This flow is typically set at 1-8 liters per minute depending on the application. After injection the chemical is mixed through a static mixer and then fed to the process.

Injection Valve: The flocculant dosing package is included with an injection valve which is spring loaded and requires a minimum of 5 psi pressure to overcome the spring and inject chemical. This allows the chemical flow to shut off immediately when the pump stops leaving the chemical line pressurized and charged to inject immediately when the pump is turned back on. The injection valve spring requires periodic maintenance with a flocculation dosing application and should be disassembled and cleaned periodically to ensure the pump performance is maintained.

20 Gal Polymer Storage Tank: The flocculant dosing pump is set up to draw chemical out of a 20 us Gal polymer storage tank built into the dosing module. This tank is intended to be filled using 5 gallon pails of polymer. The tank is sized to handle the polymer dosing rates for most applications. For example when running on a site at 300 us gpm and dosing the polymer at 5 ppm as product the operator would be topping up this tank every 2-3 days.

Liquid flocculant has a tendency to settle out when it is not consumed after a week or two. In these applications it is important the operator periodically mixes the flocculant in the flocculant storage tank. This can be done using a drill mixer which can be purchased on amazon and run with a standard battery powered drill.

Optional Larger Remote Polymer Storage Tank: There can be higher flow and higher dosing applications where the on board 20 us GAL polymer storage tank is not large enough and would require to frequent refill frequencies. In this case the pump can be set up to draw polymer from an external tank. In the remote tank application, a low level ball float switch can be installed in the larger tank or tote and wired into the panel to trigger a low chemical tank warning alarm to notify the operator when the tank requires replacement. If mixing the polymer with a hand drill, it is important to protect the level switch in the tank to prevent it from begin wrapped up in the mixer.

Speed Controlled Submersible Mixers: The power distribution and control panels are built with automation to control submersible tank mixers that are supplied separately and shipped loose. A duplex receptacle box is mounted below the control panel where the submersible mixer can be plugged in to and operate automatically with the control system.

These mixers are designed to mix a flocculation tank feeding a clarification process. Variable speed controllers are mounted inside the control panel to allow the rpm of the mixer to be reduced to match tank size and give a gentle rolling floc mixing in tanks rather than a rapid mixing that can shear floc reducing clarification performance.

These submersible mixers can be installed in external weir tanks and frac tanks for chemical mixing processes. Although the main objective of these mixers is to allow for a flocculation mixing process, the mixer can be run at full speed and used for mixing tanks for coagulation, pH adjustment, oxidation, reduction, and adsorption processes.

This device is controlled via a hand/off/auto selector switch mounted on the inner swing panel. In manual the device will run as long as the Emergency stop button is not pressed, in Auto the device will run if the controller is providing the run signal.

In some applications the mixers can be left off and then used to stir up a tank of settled solids prior to evacuating the tank for wastewater disposal.

Dosing and Control Module Process Configurations are designed for flexibility depending on the process and application.

Three different configurations are shown below to depict how the dosing and control module can be used in the field with external tanks and transfer pumps to achieve different treatment objectives. These are meant to show examples of how the system could be applied but not limit the process designer to only these configurations.

FIG. 15 shows a maximum flow configuration.

In this configuration, as an example, a 200 usgpm slip stream of the main flow stream at 1600 usgpm, is processed through the 4″ static mixer on the DMA module. The coagulant is injected on the inlet of the mixer at 30 1/hr to achieve a 120 ppm overall dose rate to the process stream.

The blended water is fed to a 20,000 us gallon frac tank and two submersible mixers are used to roll the tank and provide 10 minutes retention time before the water is overflowed into a second 20,000 us gal frac tank for flocculation mixing. The two flocculation mixers are speed controlled to prove a gentle rolling mixture.

The flocculant dosing pump is set up to dose at 1.8 l/hr to provide a 5 ppm dose rate of polymer with 10× more capacity to dose at higher rates if needed. The flocculant is made down, aged and injected into the flocculation tank at the interface of the submersible mixers to achieve a rapid mixing effect at the injection point.

Water from the flocculation tank will then flow to a clarifier, or settling pond where the clarified water is then treated with downstream processes.

The cleanest water from the process is fed back through service water pump for making down flocculant.

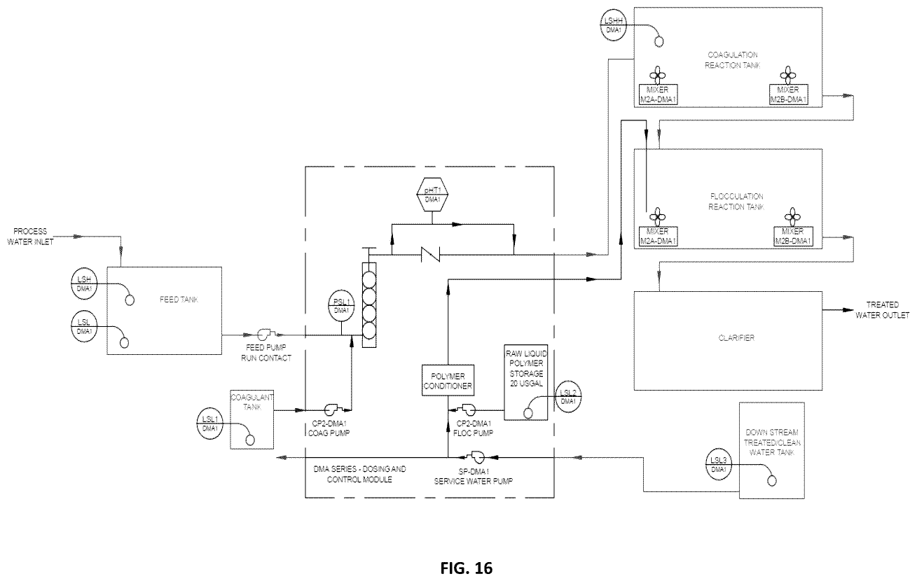

FIG. 16 shows a maximum reaction time configuration.

In this configuration the objective could be to achieve a long coagulation time to promote precipitation of heavy metals. In this scenario, the coagulant is added on the inlet of the static mixer with the full process flow running through the mixer, the pH meter is set up to monitor the pH after the coagulant is mixed. The coagulant dosing can be set to maintain a pH setpoint after the static mixer or be set to dose at a fixed dosing rate determined through bench testing, and setting ppm dosing rates that are matched up with operating flow rates.

The water stream is then sent to a coagulation reaction tank where one or two of the submersible mixers are used to roll the tank, keeping solids in suspension and allowing the metals precipitation process to reach completion. Depending on the tank size, only 1 mixer may be required in this tank. In this case it would be beneficial to move the other M1A mixer to the feed tank to ensure the water fed to the dosing system is a continuously blended stream. It is important to note that if a tank is being pumped down with a submersible mixer installed, that the low level switch is positioned to ensure at least 12″ of water remains above the mixer blades at the minimum level.

Water then flows by gravity to the flocculation tanks were one or two speed controlled flocculation mixers are used to mix the flocculation tank. The made down flocculant is fed directly to the flocculation tank ideally so the flocculant is mixed at the submersible mixer impellers to achieve an initial rapid mix.

Flocculated water is then sent to the downstream clarification process by slow flow gravity to maintain the large, fast settling, flocculation, etc.

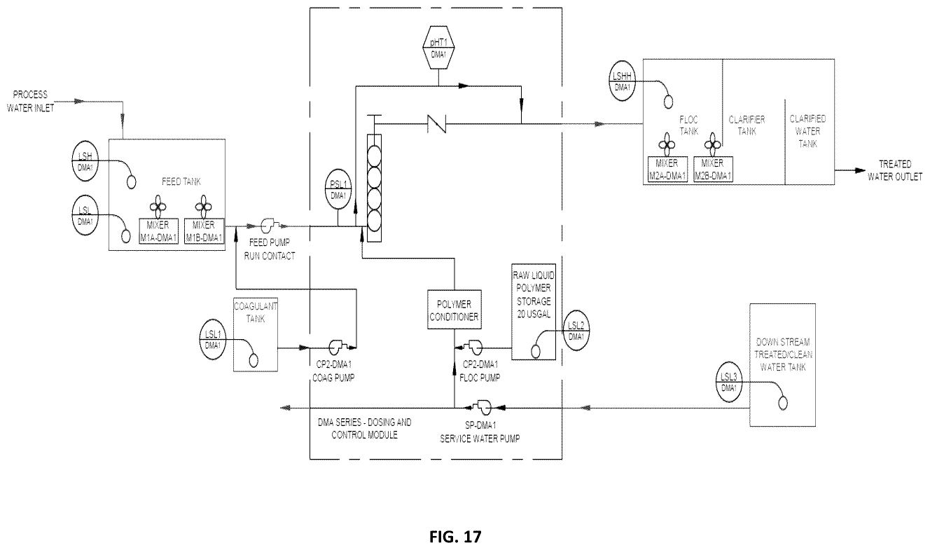

FIG. 17 shows a feed pump mixing configuration.

In this configuration the feed pump controlled by the dma module is used as a static mixer for the coagulant dosing. In this case the pH reading is taken on the inlet to the static mixer in the module. This configuration allows the static mixer in the module to be used as the rapid mixing stage for the flocculant. The water could then go straight to a clarifier in a simpler configuration or could go to a weir tank where the first stage can be converted into a flocculant mixing tank.

The best flocculation and settling will occur if the flocculant is given time to slow mix prior to entering the settling chamber though this may not always be feasible depending on what sort of tanks are available for the project.

In this application the coagulant can be made down and diluted inside the dosing module before it is transferred to the inlet of the feed pump. This provides the advantage of reducing the concentration in the external transfer lines, reducing the variability of the chemical concentration being injected into the process line.

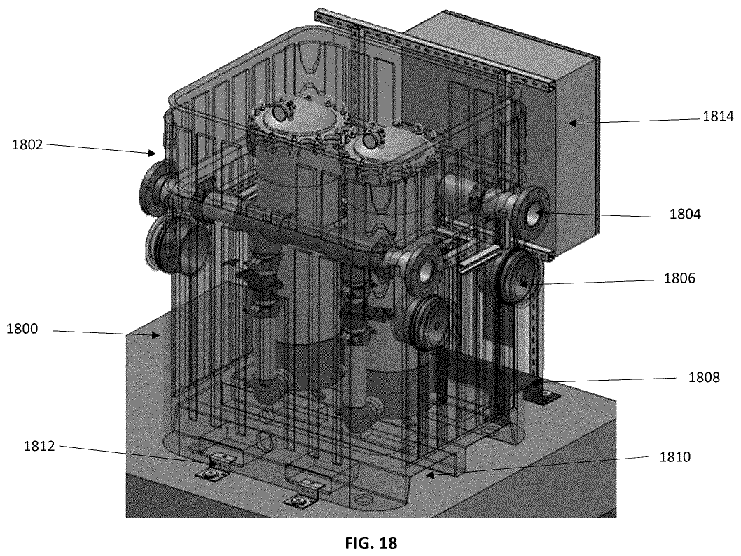

FIG. 18 shows an isometric view of the filtering module

The filtering module 1800 has a rectangular plastic insulated cube housing the filtering components, a plastic insulation extension 1802 is mounted above the open-top cube to allow a taller filtering unit to be installed in the housing. A control panel 1814 is mounted on the exterior wall similar to the insulated dosing module 500 enabling an automation process. Process Inlet ports 1804 are mirrored and installed on both ends of the module so the process inlet fluids can enter or exit either side of the module as required when installing multiple parallel filter modules 1800. Side access holes 1806 are installed below the fluid ports allowing access to the filter isolation valves inside module. Lifting attachment 1808 can be installed at the bottom of the module below the control panel creating a folk pocket below the heavy panel for forklifts to balance the weight distribution when transporting a module where the weight of the panel would make the standard forklift pockets 1810 unstable. The lifting attachment has bolt down tabs integrated and two bolt down tabs 1812 are installed at the opposite end of the module allowing the module to be anchored onto the ground for stability in areas of heavy wind and seismic activity.

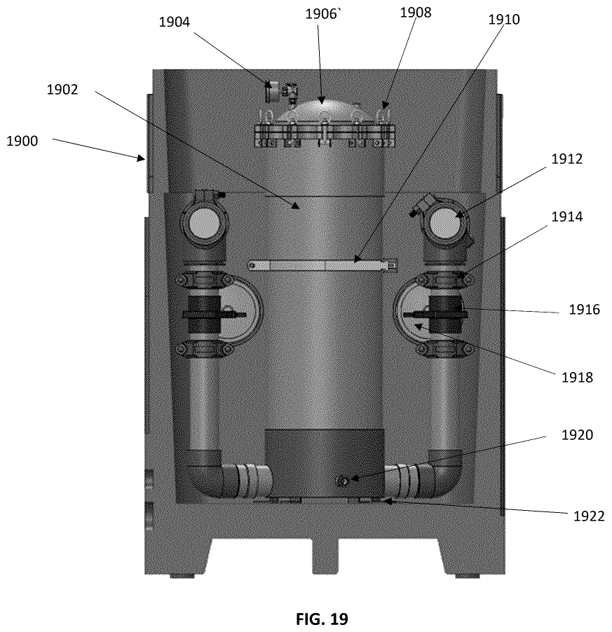

FIG. 19 shows an interior cross section view of the filtering module

The interior filtering module 1900 in this view has cartridge filters 1902 with a pressure gauge 1904 installed above to monitor the feed pressure within the filter housing. The filtering unit is secured by clamp 1910 supported by struts and bolted on the side of the filtering module 1900. The bolt down tabs 1922 rest on the floor of the filtering module 1900 but do not bolt through the floor of the module to maintain the watertight integrity of the module when installed. The cartridge filters can be accessed through the top hatch 1906 with quick-opening rings 1908. Process feed lines 1912 are clamped with grooved pipe clamps 1914 to allow for removal and servicing. Isolation valves 1916 are installed in the vertical pipeline to allow the operator to isolate one cartridge filter leaving the other filter online when changing filter elements. Access holes 1918 are installed at the wall of the module allowing access to the shutoff valve from the exterior of the module. Drain port 1920 is installed at the bottom of the filter housing for draining fluids for shipping or to remove some water when changing filters.

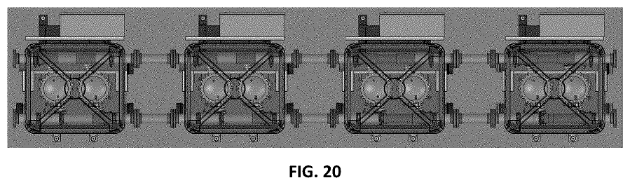

FIG. 20 shows an example of how an embodiment of filter modules can be connected in parallel to accommodate higher flow requirements on a site.

In this configuration, multiple filtering modules are connected in parallel with inlet and outlet ports to accommodate high flow rate applications. This is achieved by fluid entering the inlet of the module and travelling through the horizontal inlet line to enter the filter housings, the end of the horizontal inlet port is shut to prevent fluid from exiting on the opposite end. Filtered fluid enters the horizontal outlet line through the filter housing and exits the module through the combined process outlet line to convey to downstream process modules.

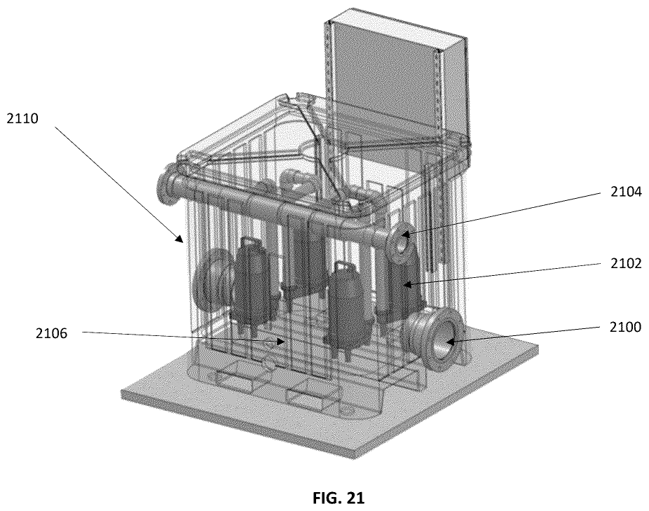

FIG. 21 shows an isometric view of the pumping tank module 2110.

The pumping tank 2106 has a rectangular plastic insulated cube tank with the pumps installed inside the tank, piping headers installed in the top section of the tank and a control panel mounted on the exterior wall similar to other modules described previously. Process water inlet ports 2100 are installed at the bottom of the module and mirrored on both ends of the wall and process water outlet ports 2104 are installed and mirrored above the inlet ports allowing fluids to enter or exit the process water outlet header and enabling multiple pumping tank modules to connect in parallel for higher flowrate applications. Alternative pumping tank inlet port could be installed in the top of the side wall of the tank module to introduce process water into the tank from the top. Multiple submersible pumps 2102 are mounted inside the plastic insulated cube to pump fluids to the outlet ports 2104 for processing. Although it is not shown in the figure, a level transmitter is installed inside the pumping tank 2106 to detect water level and allow the automated control system to stagger starting and stopping of multiple pumps to match the incoming flow rate. A high-water level alarm switch not shown would be installed in pumping tank 2106 to warn of a high-level alarm and stop incoming water. In another embodiment of this pumping tank module a plastic insulated extension similar to 1802 can be mounted on the top of the pumping tank 2106 to allow the process water outlet port 2104 and other necessary piping and electrical ports to be installed in a section of the module above the maximum water line to avoid potential water leaks through fittings in the wall of the process tank. This would increase the maximum height of the water inside the pumping tank 2106 and maintain the watertight scal inside the pumping tank 2106.

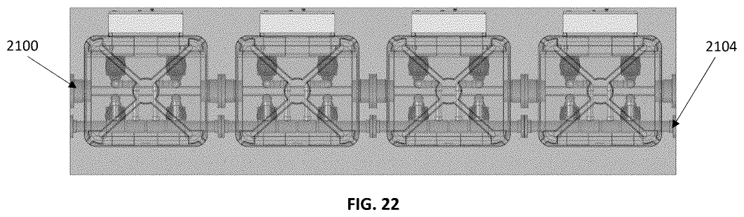

FIG. 22 shows a top view of an example of how an embodiment of pumping tank modules can be connected in parallel to accommodate higher flow requirement flow on site.

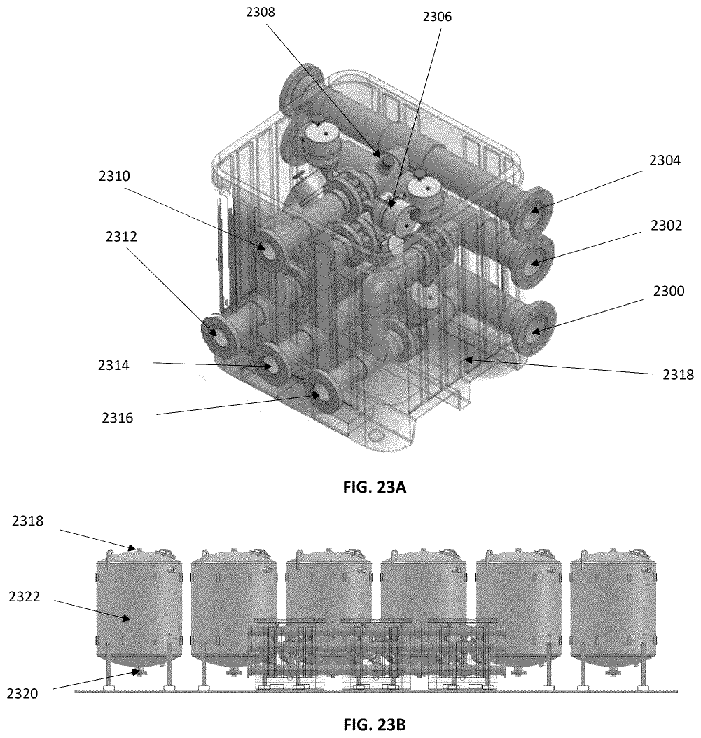

In this configuration, multiple pumping tank modules are connected in parallel to accommodate high flow application similar to FIG. 20. In this configuration, each module is capable of processing flow up to 400 GPM, four modules connected in this figure can increase the processing flow rate up to 1600 GPM. This is achieved by connecting the inlet port 2100 and outlet port 2104 from each module in series to allow the fluid to enter the module through the connected horizontal inlet line, the end of the horizontal inlet port is shut to prevent fluid to exit on the opposite end. Fluid is then pumped to the combined horizontal outlet line and exit the module through the outlet port to convey to downstream process modules. FIG. 23A shows an isometric view of one style of valving module 2318.

The figure illustrated has a control panel and plastic lid to cover the module housing which are removed from this figure for simplicity. The valving module is used for processing water through depth media filter vessels such as sand filters, multimedia filters, micro sand filters, carbon filters, ion exchange filters, and specialty adsorption media filters and transferring filtered water for downstream processing, the valving module is also used for backwashing and rinsing filter vessels. Similar to the filtering module, the plastic insulation extension 1802 can be attached to the valving module to provide a larger module for housing the piping and valves. This extension can also be lifted off giving the operator better access to valves. In this embedment of the valving module, the process inlet port 2300 is installed at the bottom of the module on both sides, waste outlet port 2302 is installed above the process inlet port, and filtered outlet port 2304 is installed above the waste outlet port. The automated valves 2306 and flowmeters 2308 are installed inside the module housing to enable automated flow control. Depending on the application, the automated valves can be modulated and controlled through the control panel to maintain a desired flow rate for filtering, backwashing, or rinsing. The flowmeters monitor the flow rate within the pipes and control the modular valves to achieve a consistent flow rate. The filter vessel inlet and outlet ports are installed on the adjacent wall of the module, the valving module can connect to two filter vessels. In this embodiment of the valving module top port vessel A 2312 is installed on the bottom left of the module, bottom port vessel A 2314 is installed on bottom middle of the module, top port vessel B 2316 is installed on the bottom right of the module, and bottom port vessel B 2310 is installed on the top of the module.

FIG. 23B shows an example of embodiment of the valving modules that can be connected in parallel to accommodate higher flows.

In this configuration, multiple valving modules are connected in parallel to accommodate multiple filtering vessels 2322. The process inlet port 2300, waste outlet port 2302, filtered outlet port 2304 are connected horizontally allowing processing water to travel across the modules for filtering. Inlet ports, outlet ports and waste ports are mirrored on each module to allow for easy parallel connection of modules. Although it is not shown in the figure, the modules are connected to the vessels with pipes or hoses. For example, top port vessel A on the valving module 2312 will be connected to the top port on the filtering vessel 2318 and the bottom port of the filtering vessel 2320 is connected to the valving module bottom port vessel A 2314.

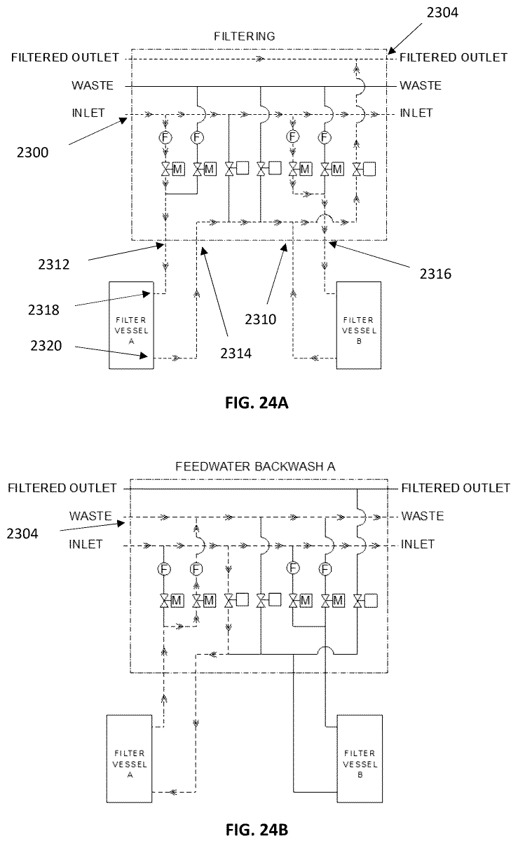

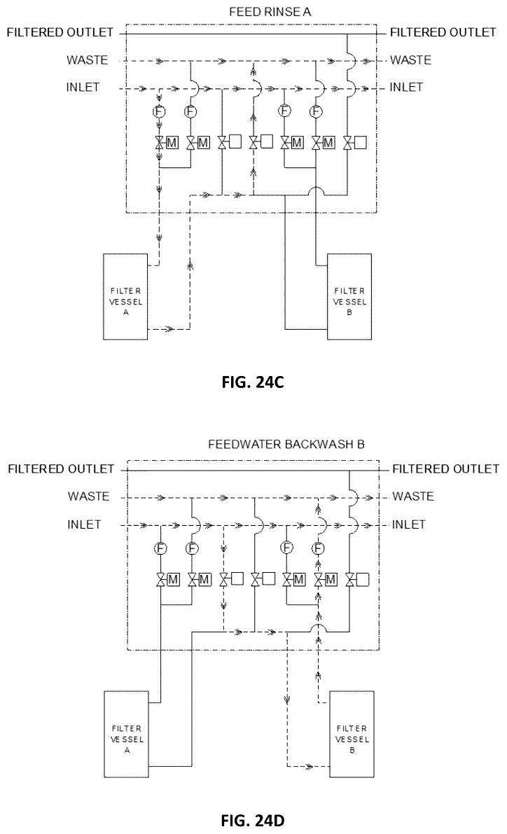

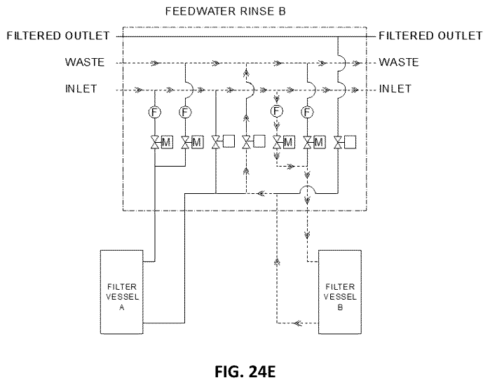

FIG. 24A, 24B, 24C, 24D, 24E illustrated different flow configurations of the valving module with the fluid flow directions denoted in arrows and the pipes used are denoted in dotted lines.

FIG. 24A illustrates the valving module under filtering operation. In this configuration, process water is fed through the inlet port 2300 and travels through the automated valves and exit from valving module top ports 2312 and 2316 and enters the vessel through the top port 2318 for filtering. The filtered water then travels from the bottom port 2320 and enters the valving module bottom ports vessel A 2314 and vessel B 2310 again and flows into the filter outlet port 2304 for downstream processing.

FIG. 24B illustrates the valving module under feedwater backwashing A operation. In this configuration, filter vessel A is being backwashed. Process water is fed through the inlet port 2300 and travels from the valving module bottom port vessel A 2314 and enters the vessel bottom port 2320 to perform backwashing of the filter vessel, the wastewater is then exiting through the top of the vessel 2318 and returns to the module through the valving module top port vessel A 2312 and travel through the wastewater line and exit the module through the waste port 2304.

FIG. 24C illustrates the valving module under feedwater rinsing A operation. In this configuration, process water is fed through inlet port 2300 and exit from the vessel top port vessel A 2312 and enter the vessel through the top 2318. The process water is then exiting from the bottom 2320 and return to the valving module through the bottom port vessel A 2314 and travel to the waste port 2304.

FIG. 24D illustrates the valving module under feedwater backwashing B operation. Similar to FIG. 24B, this configuration performs backwashing of the second filter vessel that is connected to the same module. The process water exits the valving module through bottom port vessel B 2310 and enters the vessel through the bottom 2320, the process water is then travel from the top of the vessel 2318 and returns to the module through top port vessel B 2316 and flow through the waste port 2304.

FIG. 24E illustrates the valving module under feedwater rinsing B operation. Similar to FIG. 24C, this configuration performs feedwater rinsing on the second filter vessel that is connected to the same module. The process water exits the valving module through top port vessel B 2316 and enters to the top of the vessel 2318. Then the process water returns to the module from the bottom of the vessel 2320 travelling through the valving module bottom port vessel B 2310 and flows through the waste port 2304.

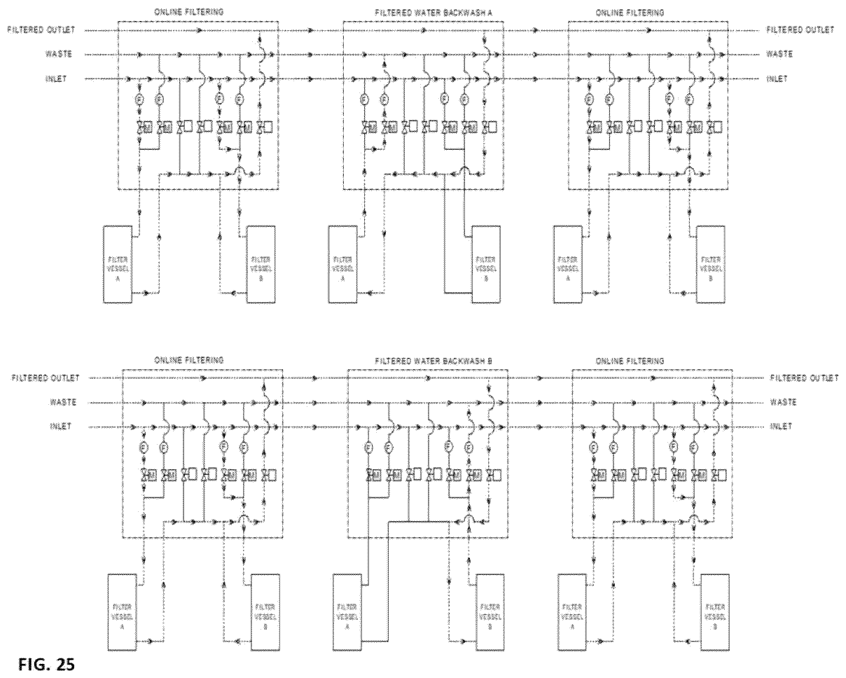

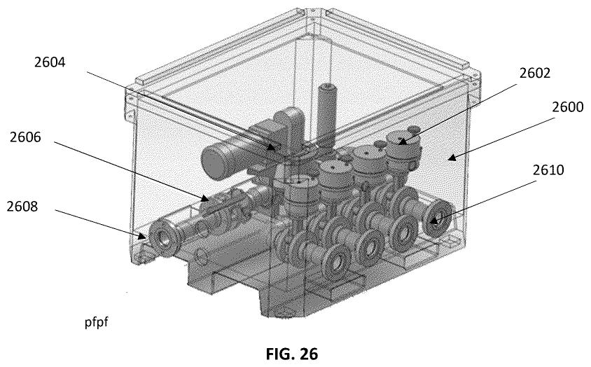

FIG. 25 illustrates an example of multiple valving modules connected in parallel. In this configuration, there would be sufficient filtered water available to backwash the filter vessels with filtered water being produced by the adjacent valving module. This poses benefits as it reduces solids contamination in the bottom of the filtering vessel and allows for backwashing of adsorbent and ion exchange filters without contaminating the vessels. In the top row of the valving modules, the middle module is performing filtered water backwashing vessel A while the adjacent modules are operating under normal filtering process as described in FIG. 24A. Some of the filtered water from the adjacent modules is fed into the middle module through the filtered outlet and exit the module through the valving module bottom port vessel A 2314 entering the vessel bottom 2320 to perform backwashing on the filter vessel A. The wastewater is then exited through the top of vessel 2318 and return to the middle module through the top port vessel A 2312 and travel through the wastewater line. The bottom row of modules in this figure operates similarly to the top row module but instead the middle module is performing filtered water backwashing of vessel B. The filtered water exits through the bottom port vessel B 2310 to enter the filter vessel B through the vessel bottom 2320, the wastewater then returns to the middle module through top port vessel B 2316 and flows through the wastewater line.

FIG. 26 shows an isometric view of one embodiment of a sludge extraction module.

The figure illustrated has a control panel mounted on the exterior wall of the module which is removed from this figure for simplicity. The module would also have other features including heating, ventilating, sump level switches and lighting described above that are removed from the drawing for simplicity. The sludge extraction module 2600 in this embodiment has four inlet ports 2610 and each inlet port has an automated valve 2602 installed to control the flow allowing the module to cycle each inlet port automatically to extract sludge constantly, pump 2604 is installed inside the module housing, the pump is capable of pumping sludges at a rate of 80 GPM and cycling the inlet ports allows the pump to extract sludges at a consistent flow rate without increasing the viscosity of the fluid within the pipe. Butterfly valve 2606 is installed at the downstream of the pump to isolate the pump for servicing if required. Sludge exits the module through the process outlet port 2608 is installed on the side of the module allowing the pump to transport sludges to downstream processes including settling ponds, thickening tanks, sludge storge tanks, geotubes, or other dewatering processes.

### Example 2

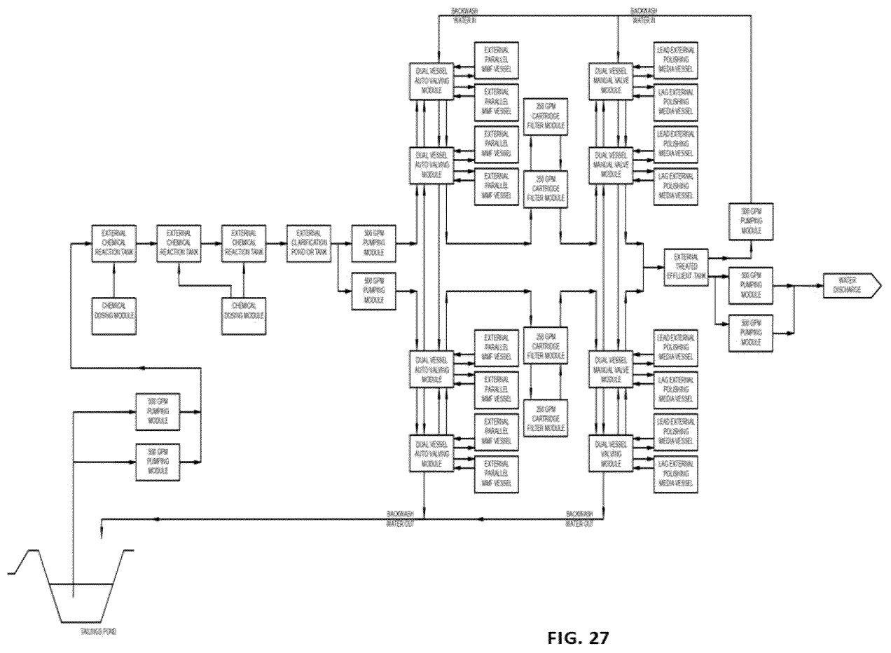

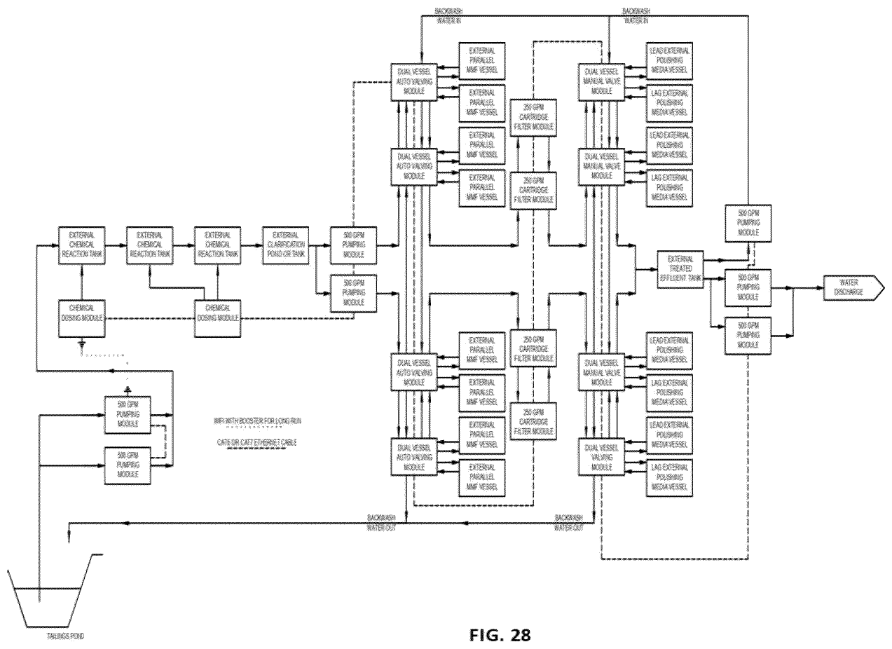

FIG. 27 illustrates a process flow diagram showing how a complex metals treatment system can be assembled by premanufactured mobile treatment modules scaled up to 1000 usgpm. In this example water is pumped from a pond or inlet tank through two parallel pumping modules.

The water is pumped using two parallel pumping modules 200 as depicted carlier in FIG. 2 into a commonly available 18,000 gallon weir tank or 21000 gallon frac tanks were submersible mixers as depicted in FIG. 14C, 14D and 14E are set up inside the tank to allow continuous mixing. These mixers are controlled by the control system on a chemical dosing module 500 as depicted FIG. 5A with the configuration shown in FIG. 6B. The chemical dosing pumps in the chemical dosing module will transfer chemicals from chemical storage tank modules 400 as depicted in FIG. 4 to the mixed reaction tanks. For example, sodium hydroxide would be used to raise pH to the desired setpoint for precipitating target metals. Water then flows by gravity through the second and third mixed chemical reaction tanks. A second chemical dosing and control module 500 as depicted in FIG. 5A with the example configuration shown in FIG. 6A. would be used to inject coagulant into the second mixed reaction tank and inject a flocculant into the third mixed chemical reaction tank.

The coagulated and flocculated water would then be processed through a clarifier to settle solids out in the bottom of the tank. A sludge extraction module 2600 as depicted in FIG. 26. can be used to connect to a piping header in the bottom of the clarification tank periodically extra sludge for higher suspended solids applications.

Clarified water is then pumped through two parallel pumping modules 200 as depicted carlier in FIG. 2. into a bank of 4 automated valving modules 2318 as depicted in FIG. 23A set up in parallel as depicted in FIG. 23B. Each automated valving module is connected to two multimedia filters and has the ability to backwash the filters back to the inlet tank or inlet pond as solids accumulate in the filter as depicted in FIG. 23B, 24A, 24B, 24C, 24D, 24E, and 25.

In this example, filtered water is then fed under pressure to the bank of cartridge filter modules 1802 as depicted in FIG. 18 set up in parallel as depicted in FIG. 20. Although it is not shown in this figure, in some cases a set of pumping tank modules 2110 as depicted in FIG. 21 will be set up in parallel as depicted in FIG. 22 after the multimedia filters so the water pressure can be boosted again to feed the downstream cartridge filter modules 1802.

Polished water leaving the filter modules 1802 would then feed manual valving modules 2318 depicted in FIG. 23A set up in parallel as depicted in FIG. 23B to process water through specialty media filters designed to remove low levels of dissolved metals as the final treatment stage. For the polishing media step in this application only manual valves would be required in the valving module since the valve position would only have to change infrequently and this can be completed manually by an operator. This treated water is then fed to an effluent storage tank.

A pumping module modules 200 as depicted earlier in FIG. 2 is set up to supply treated effluent as backwash water in some applications the filtered water from the VMA modules directly can be used for backwashing or the inlet water to the VMA modules could be used for backwashing depending on the application.

Two parallel pumping modules 200 are installed on the outlet of the treated effluent tank to pump water to the discharge pipeline and final effluent point.

FIG. 28 illustrates a process flow diagram shown in FIG. 26 with the interconnecting ethernet network cables that would achieve a fully integrated water treatment system using the modular control method applied to the mobile treatment modules.

This figure is the same as the above figure but with dashed lines showing the ethernet communication cables that would be installed between each of the treatment modules. These ethernet cables allow each module to look at the status of the upstream and downstream module allowing the system to start when all modules are ready and stop if a critical alarm occurs on a module on the network. Each module has an independent functioning control system and the operator can select on site which module on the network is the upstream and downstream module for start/stop and pause signals.

### Example 3

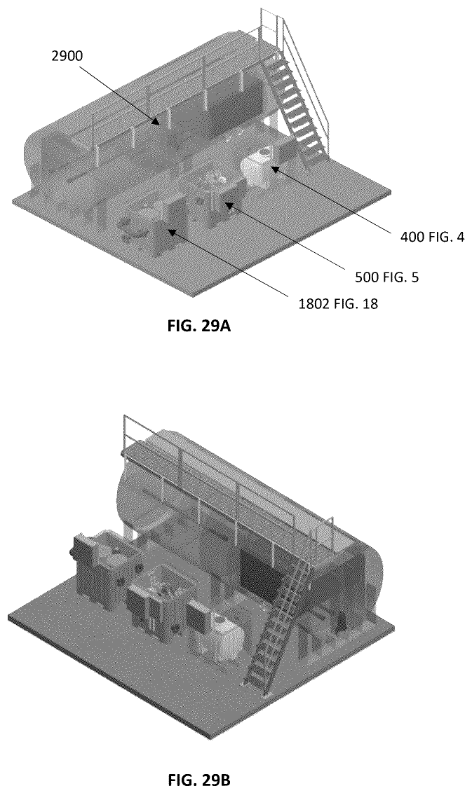

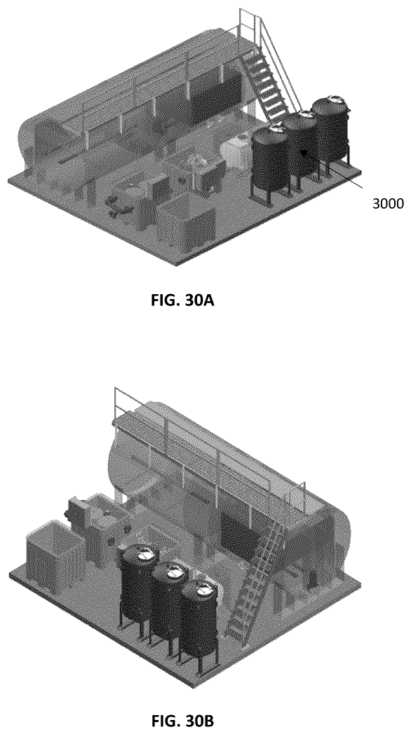

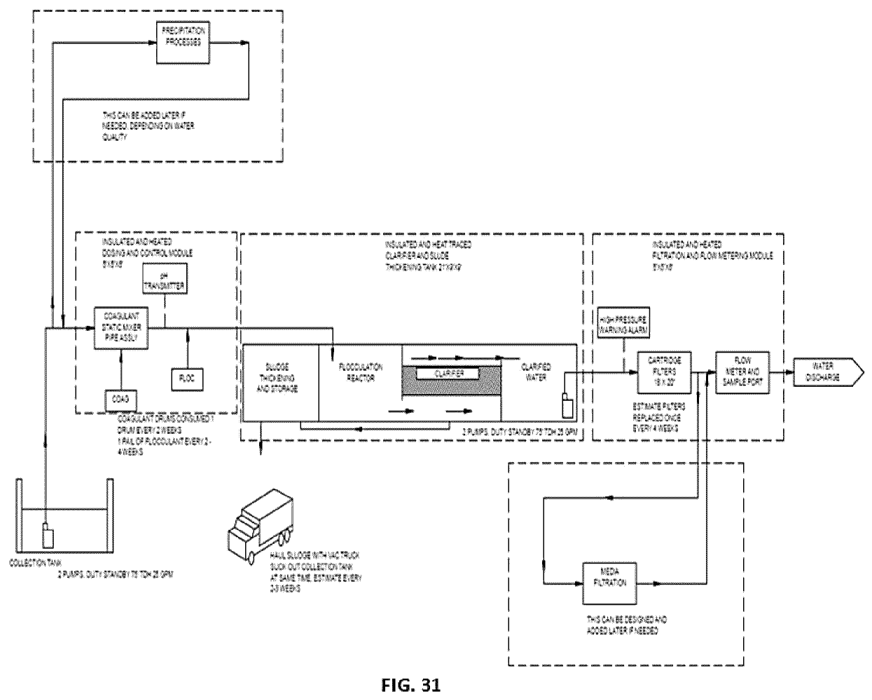

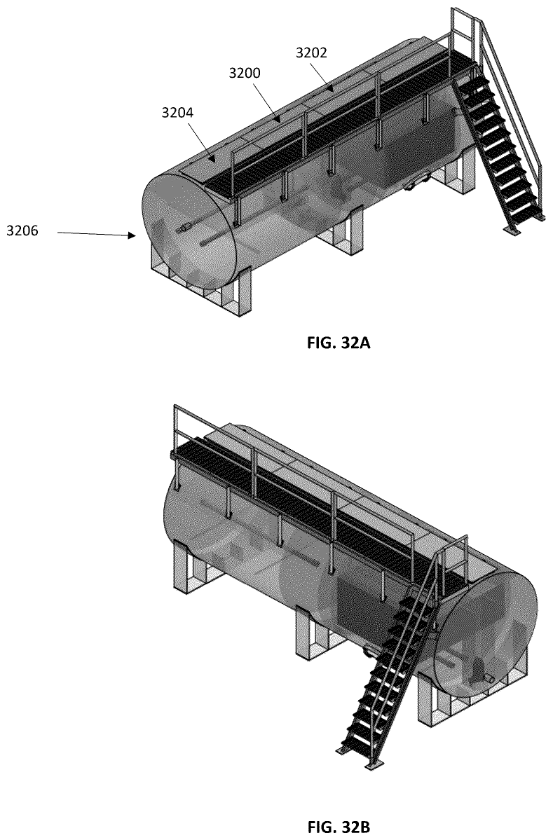

Illustrated in FIG. 29A, FIG. 29B, FIG. 30A, FIG. 30B, FIG. 31, FIG. 32A, and FIG. 32B.

FIG. 29A shows a perspective view of the layout of a base treatment plant relating to a specific case study having a compact footprint to fit within the space available on the site.

FIG. 29B shows an alternative perspective view of the layout of a base treatment plant.

FIG. 29A and FIG. 29B illustrate the solution developed for this application. Care has been taken to maximize system performance, reduce overall project costs within the available footprint.

Water from the feedwater sump not shown is pumped into the inlet of the chemical dosing module 500 from FIG. 5 were a coagulant is added upstream of an integrated static mixer. The coagulant is drawn from the chemical storage tank module 400 from FIG. 4 and fed to the integrated mixer. A flocculat dosing pump on the chemical storage module makes down a dilute flocculant and injects it into the flocculation tank section of the cylindrical clarifier 2900. Clarified water is pumped out of the cylindrical clarifier 2900 into the filtering module FIG. 1802 from FIG. 18. Filtered water is then discharged to sanitary sewer.

FIG. 30A shows a perspective view of the layout of a base treatment plant with expanded treatment stages.

FIG. 30B shows an alternative perspective view of the layout of a base treatment plant with expanded treatment stages.

FIG. 30A and FIG. 30B illustrate how the system has been designed to be expandable to include media filtration and upstream chemical reaction processes as needed during the course of the project. The image below shows the layout of the expanded plant with media filtration and additional chemical precipitation processes if needed.

Filtered water leaving the cartridge filter module 1802 from FIG. 18 is fed under pressure to the media filtration vessels 3000 piped in series. The first and second vessel would house granular activated carbon for removal of hydrocarbons, PAHs and VOCs. The third vessel would house a specialty metal removals media to remove targeted metals found in the water.

FIG. 31 shows a process flow diagram with expanded treatment stages.

The treatment process presented in FIG. 31 is developed for the intention to, adjust pH, remove suspended solids, and remove particulate metals in the base treatment process to discharge to sanitary sewer. Additional treatment stages can be added as needed to treat dissolved metals, polyaromatic hydrocarbons (PAHs) and other hydrocarbon contaminants.

Water will be pumped from the collection sump to the treatment plant with a submersible pump that would be automatically controlled by the chemical dosing and control module 500. Water will be pumped through insulated and heat traced hoses up to a chemical dosing and control module 500 where a coagulant and a flocculant will be added to clarify the water and allow the solids to drop out. The coagulant can be selected with the capacity to reduce the pH during construction periods where high pH water is generated from concrete infrastructure work.

A coagulant chemical storage tank module 400 is used to store the coagulant.

A flocculant storage tank inside housed inside the chemical dosing and control module 500 will house the raw liquid polymer.

Water will then be fed into a mixed flocculation tank where the solids will conglomerate and gently flow through a tube settling clarifier to collect in a clarified water tank. Sludge will accumulate in the bottom of the clarifier and will be transferred automatically into a larger sludge thickening and storage tank.

The sludge thickening tank is designed to store 2000-3000 gallons of sludge with sufficient retention time to allow the sludge to thicken to reduce transportation and disposal costs on the project. As an example, a 20′mini weir tank could fit into the space available on site and would store 800-1000 gallons of sludge at 1.5-2.5% solids before it would need to be pumped out 2-3 times per week. When it is pumped out the sludge is removed with a large amount of free water in the tank at the same time generating a larger more dilute volume waste stream leading to a 6-fold increase in waste disposal costs.

To maximize utility of the space on site, the flocculation tank, clarification tank sludge thickening tank and clarified water tank will be designed together as a custom 22′×8 ft tank. This tank will be heated and insulated and built with a catwalk and staircase for top access for extracting sludge, inspecting operations, and performing additional maintenance as required.

FIG. 32A shows a perspective view of a clarifier with sludge thickening 3206.

This is an example of a clarifier that could be used with the treatment modules. Water is fed to the middle flocculation tank 3200 where a submersible mixer is installed to gently mix the water in this tank. Water then flows into the clarified media filter section 3202 where solids settles out below the media and clarified water collects at the top of the clarifier media. Clarified water then flows through to the clarified water tank 3202 where it is pumped out to the next treatment stage. Sludge that accumulates below the media would then be transferred over to the sludge settling tank 3204 where the sludge sits and settles out further thickening up. Excess water overflows from the sludge thickening tank back into the flocculation tank and is fed through the process a second time.

FIG. 32B shows an alternative perspective view of a clarifier with sludge thickening.

A submersible transfer pump is installed in the clarified water outlet tank to pump the water through a filter module to polish fine solids and ensure the water going to the sewer is always clean. A pressure switch on the inlet of the filters will warn the operator when the cartridges require replacement. The cartridge filter will also provide solids polishing filtration to enable the use of a media filtration technology downstream as required to remove metals, PAHs and hydrocarbons as required.

The cartridge filters provide a second degree of environmental safety in the proposed design which is valuable given that we are using chemicals in the clarification process. If incoming water quality changes or a chemical tank runs dry for example, this could result in an issue with floc that could lead to solids leaking through the clarifier. With this design the cartridge filter would catch these solids rather than discharging them to the sewer. The pressure switch would warn the operator of the issue so the system could be inspected and chemical dose rates tuned as required to maintain smooth operation.

### Hydrocarbon Treatment Stage

If required, two heated insulated carbon vessels could be installed down-stream of the cartridge filters to filter out PAHs, hydrocarbons and other organic compounds found in the Center Block Environmental Groundwater Investigation.

### Media Based Metals Polishing Treatment Stage

If required a metals scavenging media vessel can be provided to treat the water leaving the carbon vessels.

### Installation and Commissioning

The treatment solution presented would be premanufactured and tested prior to delivering to the site to allow for quick and easy installation. We would place the clarification and thickening tank on site with a crane and place the treatment modules with a telchandler or fork truck. We have included flex hoses that are insulated and heat traced for quick interconnecting between the modules. The treatment modules and control system will have a factory electrical certification. There will be some interconnecting of wires between equipment on site that can be completed quickly on site.

### Example 4

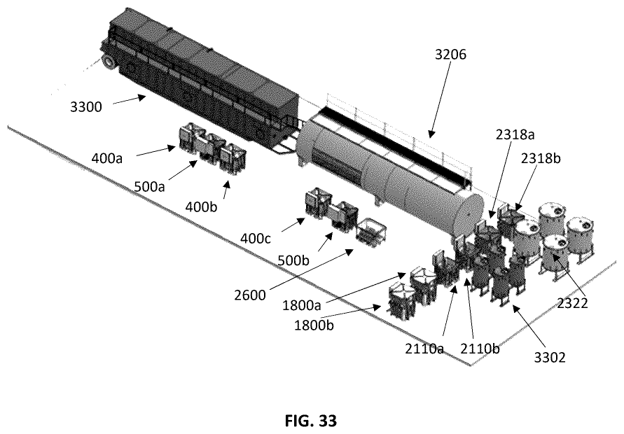

FIG. 33 shows an isometric view of an 800 gallon per minute treatment plant set up using treatment modules described in the previous illustrations. Interconnecting piping would be installed between modules and between modules and tanks. This piping is not shown in this current image.

Contaminated water fed into the mixed reaction tank 3300 where side access submersible mixers showing on FIG. 14D labeled 1440 are installed to mix the tank. These mixers are controlled by the chemical dosing and control module 500a. Two chemical storage tank modules 400a and 400b are used to store two different chemicals for use in the mixed reaction tank 3300. In this case 400a is storing sodium hydroxide while 400b is storing hydrogen peroxide.

Water then flows by gravity into the clarifier 3206 where a coagulant is and a flocculant are injected into mixing chambers of the clarifier using the dosing module 500b. Chemical storage tank module 400c is storing a coagulant, in this case Ferric Sulfate, while the flocculant is stored inside the flocculant storage tank 622 inside the chemical dosing module 500b.

As sludge accumulates within the clarifier, sludge is withdrawn using the sludge extraction module 2600 and is pumped off to a settling pond, or geotubes or another dewatering process not shown.

Clarified water accumulates in the outlet tank of the clarifier and submersible pumps are installed inside that clarified water tank and are powered and controlled by the control panel on the valving modules 2318a and 2318b. Clarified water is pumped through the valving modules and through the multimedia filters 2322. The valving modules are periodically backwashed automatically using filtered water or the feed water depending on the application. This backwash wastewater can be sent back to the beginning of the process or sent to the settling pond, geotubes or other dewatering process.

Filtered water then accumulates in the pumping tank modules 2110a and 2110b which are connected in parallel. Submersible pumps installed in the pumping tank modules can provide pressurized water to feed the downstream cartridge filter modules 1800a and 1800b where fine particulate is removed.

Water filtered with the fine particulate filter are then processed through polishing media vessels 3302 that can hold specialty adsorbent medias targeted at removing of heavy metals, in this case copper, nickel, zinc and arsenic.

Each module shown has dedicated control panels that are connected together on an ethernet network allowing the modules to communicate together and start and stop as a fully integrated treatment plant.

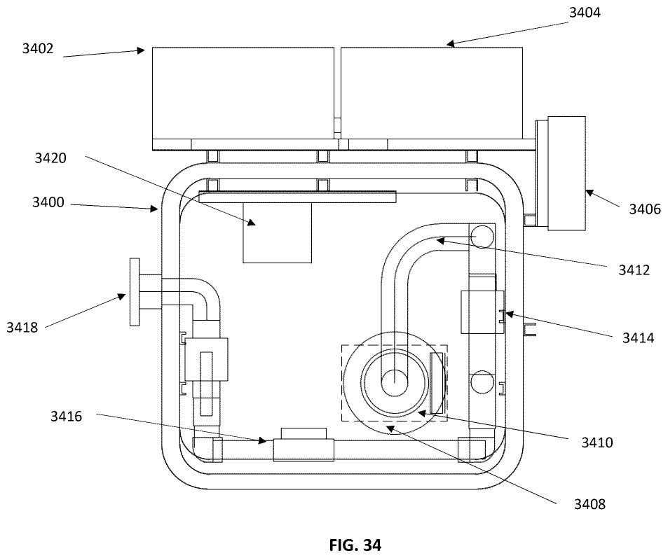

FIG. 34. shows a plan view layout of a well head pumping module.

The well head pumping module 3400 can be built with an automated control panel 3402 and power distribution panel 3404 as well as a heat trace breaker panel 3406. A well casing access port 3408 is cut into the floor of the well head pumping module 3400 to allow the well head pumping module to be placed over top of the well casing 3410 protruding from the ground. The submersible well pump can be raised and lowered into the well easily with the lid of the well head pumping module removed. If required a boom truck or other heavy machinery can obtain overhead access to raise and lower the pump if required. A flexible pump discharge hose 3412 on the outlet of the pump can be connected to the piping header 3414 mounted on the side wall of the well head pumping module 3400. A flow meter 3416 can be installed in the module to monitor and control flow rate. The water exits the well head pumping module 3400 from outlet fitting 3418 and would be conveyed through heat traced and insulated piping in a cold climate application.

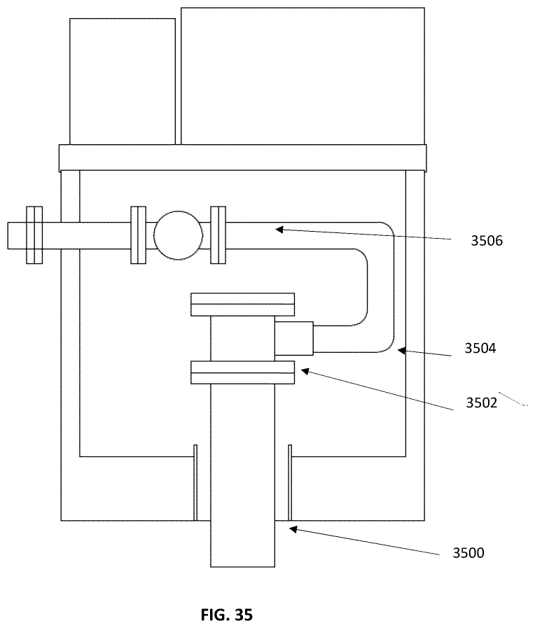

FIG. 35. shows a cross section view of a well head pumping module.

An access hatch 3500 is cut in the floor of the well head pumping module to allow the existing well casing to slip up into the enclosed heated and insulated chamber. A sealed well head fitting 3502 can be bolted onto the top of the casing for larger pump installations. A flexible discharge hose 3504 can provide a flexible connection between the removable sealed well head fitting 3503 and the piping header 3506 mounted on the side wall of the well head pumping enclosure 3400.

When pumping and treating groundwater, a production well is drilled and a submersible well pump can be used to pump the contaminated groundwater from the well. Piping, instrumentation, power distribution panels and control is often required at the well that is tied back to the main treatment plant. Well sheds are typically built at the location of the pumping well to house this equipment. These sheds are costly, expensive to ship and take longer to build than the well head pumping enclosures.

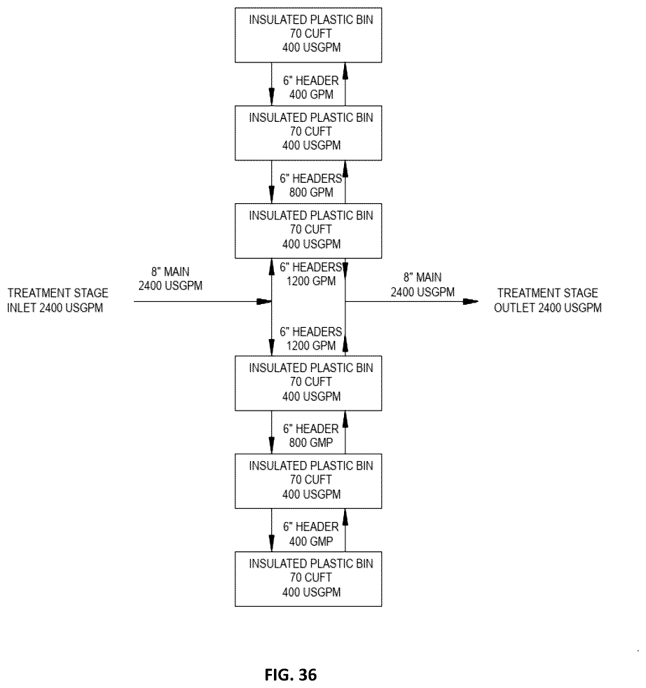

FIG. 36. illustrates how 6 treatment modules each with 400 usgpm treatment capacity built with 6″ headers can be piped in parallel with one main feed line sized at 8″ diameter or lager for a total treatment flow rate of 2400 usgpm per train.

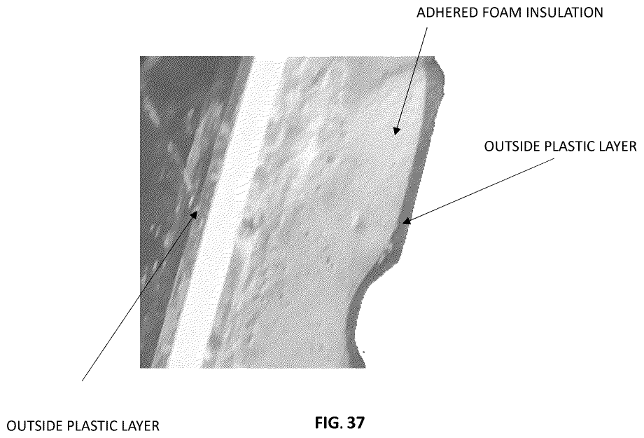

FIG. 37 illustrates the structure of a typical insulated wall of a module having foam insulation.

The treatment modules presented in this description are housed inside insulated plastic bins have an approximate outside dimension of 4′long×4′ wide×4′ high with a maximum working volume of less than 70 cu ft. When extended with two removable 2″ extensions as described to house taller water treatment components these modules would have an approximate outside enclosure dimension of 4′long×4′ wide×8′ high and have a maximum working volume of less than 100 cu ft. If a slightly wider or larger module housing is required for certain modules or components, then the module could be built as shown but housed inside custom manufactured compact steel framed boxes with service hatches on both sides and top allowing modules to be built to larger outside dimensions of approximately 6′ long×6 ‘wide×4’ high extendable to 6′ high and have a maximum working volume of less than 300 cu ft. In some cases the module housing could be built by chopping a conventional 40′ long high cube ISO container into qty 10, 4′ sections each with outside dimensions of 8′wide×9.5′ tall×4′ deep. In this configuration a standard ISO container double door could be welded onto one end to provide a large service hatch and a standard ISO container style 8′×9′ sealed wall could be welded in on the other end to form the largest size treatment module that is serviced and operated through one large opening on the front end. This design of module would also have a working volume of less than 300 cu ft.

The dimensions presented only describe the base module housing not for the entire built module. When the module is built with inlet ports outlet ports electrical boxes and accessories mounted on the exterior of the module housing.

By housing the water treatment components that require electrical integration and piping requiring protection from the elements inside the module that is serviced and operated from outside, much larger processing flow rates can be achieved than with a conventional water treatment equipment housing built with entry doorways and walking paths for servicing equipment.

The insulated plastic bins can integrate 6″ diameter main lines and 4″ branch lines and components allowing modules to process up to 500 usgpm of water flow within less than 70 cu ft of working space and can be expanded by connecting in parallel for plants to process 2400 usgpm as shown in FIG. 36. The custom manufactured steel frame boxes can integrate 8″ diameter main lines and 6″ branch lines and components allowing modules to process up to 1200 usgpm of water flow within less than 300 cu ft of working space and can be expanded by connecting in parallel for plants to process 5000 usgpm as shown in the figures. The custom modified ISO Container modules can integrate 10″ diameter main lines and 8″ branch lines and components allowing modules to process up to 8000 usgpm of water flow within less than 300 cu ft of working space.

Numerous different modular systems are known for water treatment. Some of the systems are ‘portable’ in that they can be either made on a trailer, or can be delivered on a flat-bed truck. Typically, the larger modular systems, built within shipping containers, have flow rates up to 350 usgpm. Smaller modules, built on trailers have considerably lower flow rates (in the region of 50 usgpm).

One of the instantly disclosed embodiments of the invention has external dimension of:
Length 43.1 in/109 cm
Width 47.8 in/121 cm
Height 46.2 in/117 cm
Height with lid 48.8 in/124 cm
An alternate embodiment of the invention has external dimension of:
Length 59.0 in/150 m
Width 46.2 in/117 cm
Height 34.9 in/89 cm
Height with lid 37.4 in/95 cm

Numerous different sized containers are commercially available that can be used in various different embodiments of the invention.

Despite the significantly smaller dimensions of the modules used, flow rates of in the region of 400 usgpm can be achieved, which is easily expandible to greater than 4,000 usgpm and higher with parallel trains.

The following are some examples of how the traditional water treatment methodology had to be redesigned to allow construction of high flow rate processing equipment fitted inside the relatively small portable modules.

Polymer Make down System.

Typically, a polymer makedown system can be purchased from manufacturers and are 4′ wide, 3′ deep and 6′ tall. These are normally skid mounted and fit inside an ISO container, then a tank is used to store the made down polymer to age the polymer before it is ready to use. Then a second pump will pump the made down polymer into the process at the desired flow rate. This type of process could not fit into the confined space of the insulated plastic bins and as a result we developed our own method of making down and aging polymer with a service water feed pump, that feeds service water to a makedown mixer. A dosing pump feeds the desired polymer dose rate required for the process directly to the service water stream. The made down solution is then fed by pressure into a blending and aging vessel which is sized to meet the aging time required to unravel the polymer. The made down polymer stream is then injected into the process directly.

Submersible pumps vs floor mount centrifugal pumps.

Centrifugal pumps are typically used and mounted on the floor of buildings and iso container for processing water. Many applications with our design we will use submersible pumps that are in the external tanks which are powered and controlled by the module control system.

### Control System Redesign.

The typical water treatment system would be built where one large plant is assembled in a shipping container or multiple containers that are designed to operate together. One control system is used to control that large system. With our design, we have to break the large system down into many smaller subsystems that can fit in the compact insulated plastic bins. To accommodate this and make it simple to integrate many bins on site to form a large plant the bins are built with their own control systems and they are set up with upstream and downstream daisy chain logic so the operator can configure the IP address of the upstream and downstream bin to ensure the integrated plant can start stop and operate together easily.

Process Static mixing.

Typically static mixers are installed with upstream and downstream flanges so the flanges can be unbolted and the mixer can be removed for maintenance. To achieve this functionality in the compact design we reconfigured the mixers to have them installed on a tee so they can be lifted up out the top of the assembly when the lid is off on the bin. This style of mixer is shown as item 608 in FIG. 6 and again in FIG. 10D.

Process Configuration for high flow.

Running 8″ or 10″ static mixers inside the bins is not achievable given their size constraints, we have developed a method for static mixing only a slip stream that is fed to the mixer and then the water is returned to a large external mixed reaction tank to achieve chemical dosing and mixing at much higher flow rates as shown in FIG. 15.

Furthermore running complex large piping inside the bins is not achievable due to the space constraints. For example, large purpose built water treatment plants designed to treat 2000 usgpm of water would typically house very large filters with large 8″ automated valve headers sized for the high design flow rate. Since this is unachieved in the compact bins we have developed a design accommodate smaller piping in the bins. Each valving module would have 6″ headers and the filters run in parallel outside the bins would be sized for 3″ or 4″ lines. More bins are put in parallel as shown in FIG. 23B and FIG. 25 to achieve very high design flow rates. Externalizing Oversized Equipment.

To achieve the higher flow rates the large equipment (tanks, media filter vessels, membrane skids) need to be housed outside the modules and the integrated automation (flow meters, automated valves, instrumentation) are kept inside the enclosure or designed and built to easily be set up on site in the external tanks.

External level switch, quick connect assemblies.

For tank water level switches, typically they are hard wired into the tanks that are installed inside the buildings and iso container systems. With the tanks external we had to develop quick connect level switch connection so the level switches can be connected to the control system on the bin and then easily installed in the tank. These connectors are shown in FIG. 5B as item 524. With the level switches already integrated (wired and tested with the control system before they leave the factory) the set up and startup on site is quick and easily.

### External Submersible Mixers.

Tank mixing is important in water treatment processes. Normally tanks are built into the system and mixers are permanently mounted on the tanks and wired and tested into the process. To accommodate the remote tank we have developed a submersible mixing solution where the mixer can be plugged into the module and then the mixer can be placed inside the tank or bolted to the side of the tank quickly and easily on site. The control for the mixer is still managed by the module and the mixer has been wired and tested at the factory. These mixers are shown in FIG. 14D, FIG. 14E and FIG. 14F.

### Filter Modules.

Bin extensions have been developed to provide sufficient interior height to allow large size cartridge filter housings to fit inside the bins. Side valve access ports have been developed to allow the operator to access filter isolation valves in the compact configuration. Main feed lines and treated water lines are installed with 6″ pipe so multiple modules can be bolted together in parallel to form lager flow rates as shown in FIG. 20. This parallel expandable feature carries through with many of the treatment modules including the Pumping Modules, Valving Modules, and Pumping Tank Modules.

### Valve Modules.

Typical automated valving headers for backwashing are built with 5 valves per filter vessel. A method of automating the filters was developed to only use 7 valves for a pair of two filters which could be achieved by taking two filters offline at the same time. This was developed to accommodate the limited space available in the valving module.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

While the examples given above show different examples of portable insulated water treatment modules, the skilled person in the art will appreciate that this is for clarity only, and that variations in placement of equipment within the modules is possible and falls within the scope of protection sought, without limitation.

The present disclosure includes systems having processors to provide various functionality to process information, and to determine results based on inputs. Generally, the processing may be achieved with a combination of hardware and software clements. The hardware aspects may include combinations of operatively coupled hardware components including microprocessors, logical circuitry, communication/networking ports, digital filters, memory, or logical circuitry. The processors may be adapted to perform operations specified by a computer-executable code, which may be stored on a computer readable medium.

The steps of the methods described herein may be achieved via an appropriate programmable processing device, embedded processing device or an on-board field programmable gate array (FPGA) or digital signal processor (DSP), that executes software, or stored instructions. In general, physical processors and/or machines employed by embodiments of the present disclosure for any processing or evaluation may include one or more networked or non-networked general purpose computer systems, microprocessors, field programmable gate arrays (FPGA's), digital signal processors (DSP's), micro-controllers, and the like, programmed according to the teachings of the exemplary embodiments discussed above and appreciated by those skilled in the computer and software arts. Appropriate software can be readily prepared by programmers of ordinary skill based on the teachings of the exemplary embodiments, as is appreciated by those skilled in the software arts. In addition, the devices and subsystems of the exemplary embodiments can be implemented by the preparation of application-specific integrated circuits, as is appreciated by those skilled in the electrical arts. Thus, the exemplary embodiments are not limited to any specific combination of hardware circuitry and/or software.

Stored on any one or a combination of computer readable media, the exemplary embodiments of the present invention may include software for controlling the devices and subsystems of the exemplary embodiments, for driving the devices and subsystems of the exemplary embodiments, for processing data and signals, for enabling the devices and subsystems of the exemplary embodiments to interact with a human user or the like. Such software can include, but is not limited to, device drivers, firmware, operating systems, development tools, applications software, and the like. Such computer-readable media further can include the computer program product of an embodiment of the present invention for preforming all or a portion (if processing is distributed) of the processing performed in implementations. Computer code devices of the exemplary embodiments of the present invention can include any suitable interpretable or executable code mechanism, including but not limited to scripts, interpretable programs, dynamic link libraries (DLLs), complete executable programs and the like.

Common forms of computer-readable media may include, for example, magnetic disks, flash memory, RAM, a PROM, an EPROM, a FLASH-EPROM, or any other suitable memory chip or medium from which a computer or processor can read.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

1. A portable water treatment system, said system comprising:
a series of portable modules where each portable module provides a water treatment task of a series of water treatment tasks, defines an enclosed interior space housing a number of interconnected water treatment components where the interconnected water treatment components are selected in dependence upon the water treatment task of the series of water treatment tasks and are disposed between a number of inlet ports of the portable module and a number of outlet ports of the portable module portable modules; wherein
each portable module incorporates a control module controlling operation of a subset of the number of interconnected water treatment components within the portable module, controlling operation of number of control components within the portable module, receiving data from at least one of another subset of the number of interconnected water treatment components, a subset of the number of control components and a number of sensors and providing data to a control system;
the series of portable modules are configured and interconnected in dependence upon one or more requirements specified for the portable water treatment system where the interconnections are established via a set of exterior pipes connecting to the number of inlet ports and the number of outlet ports of each portable module;
one or more inlet ports of the number of inlet ports of a defined portable module of the series of portable modules receive water for treatment from a water source whilst one or more outlet ports of the number of outlet ports of another defined portable module of the series of portable modules provided treated water to a subsequent water system;
the series of portable modules of the portable water treatment system are deliverable to a location in one or more deliveries for assembly at the location; and
a control system operatively linked to each control module of the series of portable modules to provide overall management and control of the portable water treatment system.

2-4. (canceled)

5. The portable water treatment system of claim 1, wherein each water treatment component of the number of interconnected water treatment components within a portable module of the series of portable modules is selected from the group comprising: pH/ORP monitor; pH/ORP controller;
float switches; flow switches; pumps; dosing pumps; injection and sampling ports; reservoirs;
filters; blowers; fans; compressors; gauges; mixers; switches; sensors; transmitters; controllers;
drives; filters; valves; automated valves; flow meters; pressure vessels; eductors; and tanks. cm 6-26. (canceled)

27. The portable water treatment system according to claim 1, wherein
each portable module comprises a lower portion comprising a base and a number of insulated sidewalls and an insulated lid;
the lower portion is watertight and comprises a fluid sensor such that the lower portion provides a spill containment and collection sump for the portable module and the fluid sensor provides data to the control panel of the portable module wherein at least one of the control module of the portable module and the control system of the portable water treatment system generate a warning alarm to notify an operator of a leak in the portable module; and
the fluid sensor is a sensor of the number of sensors.

28. The portable water treatment system according to claim 1, wherein
each portable module comprises a lower portion comprising a base and a number of insulated sidewalls and an insulated lid;
the lower portion is watertight and comprises a fluid sensor such that the lower portion provides a spill containment and collection sump for the portable module and the fluid sensor provides data to the control panel of the portable module wherein at least one of the control module of the portable module and the control system of the portable water treatment system generate a warning alarm to notify an operator of a leak in the portable module;
the fluid sensor is a sensor of the number of sensors; and
a corner between an insulated sidewall of the number of insulated sidewalls and an adjacent insulated sidewall of the number of insulated sidewalls has a planar geometry within which at least one of an inlet port of the one or more inlet ports and an outlet port of the one or more outlet ports is disposed.

29. The portable water treatment system according to claim 1, wherein
a subset of the series of portable modules can be disconnected and transported to another location in one or more other deliveries for assembly at the another location as part of another portable water treatment system.

30. The portable water treatment system according to claim 1, wherein
each portable module of the series of portable modules is selected from the group comprising a pumping module, a chemical dosing module, a chemical storage tank module, a sludge waste module, a sludge extraction module, a valve module, a pump module, a filtering module, a filtration module, a chemical dosing module, a mixing module, an air supply module, an aeration module, a compressor module, and a well head enclosure module.

31. The portable water treatment system according to claim 1, wherein
each inlet port of the one or more inlet ports of each portable module of the series of portable modules is in a defined position on a sidewall of the portable module of the series of portable modules;
each outlet port of the one or more outlet ports of each portable module of the series of portable modules is in a defined position on another sidewall of the portable module of the series of portable modules opposite the sidewall of the portable module of the series of portable modules;
each outlet port of a portable module of the series of portable modules can be connected to an inlet port of another portable module of the series of portable modules via a straight pipe connection as the defined position on the sidewall and the defined position on the another sidewall are mirrored relative to an axis of the portable module of the series of portable modules.

32. The portable water treatment system according to claim 1, wherein
each portable module of a subset of the series of portable modules further comprises a ventilation fan coupled to the control module and an air intake coupled to the fan at one end and an exterior environment at another distal end for managing heat buildup with the portable module during its operation.

33. The portable water treatment system according to claim 1, wherein each portable module of the subset of the series of portable modules further comprises a heater coupled to the control module for operation when the portable water treatment system is established within a location having a cold climate.

34. The portable water treatment system according to claim 1, wherein
each portable module of a subset of the series of portable modules further comprises:
a temperature sensor coupled to the control module;
a ventilation fan coupled to the control module;
a set of louvers; and
a heater coupled to the control module; and
the control module selectively operates the ventilation fan and the heater to maintain a consistent temperature within that portable module.

35. The portable water treatment system according to claim 1, wherein
each portable module of a subset of the series of portable modules further comprises:
a temperature sensor coupled to the control module;
a ventilation fan coupled to the control module; and
a heater coupled to the control module; and
the control module selectively operates the ventilation fan and the heater to maintain a consistent temperature within that portable module.

36. The portable water treatment system according to claim 1, wherein
each portable module comprises a lower portion comprising a base and a number of insulated sidewalls and an insulated lid;
the lower portion is watertight and comprises:
a first pair of fork pockets on a first side of a base of the lower portion to engage a pair of forks upon a forklift truck such that the portable module can be lifted and moved by the forklift truck; and
a second pair of fork pockets on a second side of the base of the lower portion to engage the pair of forks upon the forklift truck such that the portable module can be lifted and moved by the forklift truck; and
the first side and second side of the base are orientated at an angle relative to one another.

37. The portable water treatment system according to claim 1, wherein
each portable module of the series of portable modules supports stacking of another portable module of the series of portable modules for shipment prior to deployment.

38. The portable water treatment system according to claim 1, wherein
each portable module comprises automation equipment coupled to the control module directly or via one or more controllers such that the portable module is capable of automating and controlling the interconnected water treatment components to perform the water treatment task of the series of water treatment tasks as a standalone system or as part of a series of portable water treatment systems of which the portable water treatment system is one.

39. The portable water treatment system according to claim 1, wherein
each portable module incorporates at least one of a connector defined by a wired data communications standard and a wireless access point operating according to a defined wireless communications standard; and
each portable module of the series of portable modules is interconnected to another portable modules of the series of portable modules by one of wired data communications via a cable connecting the connectors of the portable module of the series of portable modules and the another portable module of the series of portable modules and wireless data communications via the wireless access points of the portable module of the series of portable modules and the another portable module of the series of portable modules.

40. The portable water treatment system according to claim 1, wherein
each portable module incorporates at least one of a connector defined by a wired data communications standard and a wireless access point operating according to a defined wireless communications standard;
the series of portable modules of the portable water treatment plant when connected together form a network; and
an operator can configure the series of portable modules by:
selecting the static Internet Protocol (IP) addresses for the control module of each portable module of the series of portable modules
defining the IP addresses of each upstream control module and downstream control module of the control module of each portable module of the series of portable modules; and
defining the pause bits and enable bits within an upstream portable module of the series of portable modules or downstream portable module of the series of portable modules that provide external pause and enable data to the control module of the portable module of the series of portable modules; and
the operator can define one of the control module of a defined portable module of the series of portable modules and a remote system as the control system.

41. The portable water treatment system according to claim 1, wherein
the portable water treatment system was established with a process comprising:
receiving a requirement for the portable water treatment system comprising the series of portable modules where the requirement defines a number of types of portable module and a number of portable modules of that type of portable modules;
coordinating shipment of the series of portable modules to a location where the series of portable modules were established from a stock of a portable modules; and
interconnecting the series of portable modules using standard pipe fitting according to the requirement at the location.

42. The portable water treatment system according to claim 1, wherein
the one or more inlet ports of each portable module of the series of portable modules comprises a pair of inlet ports where an inlet port of the pair of inlet ports is in a defined position on a sidewall of the portable module of the series of portable modules and the other inlet port of the pair of inlet ports is in the defined position on another sidewall of the portable module of the series of portable modules opposite the sidewall of the portable module of the series of portable modules;
the one or more outlet ports of each portable module of the series of portable modules comprises a pair of outlet ports where an outlet port of the pair of outlet ports is in another defined position on the sidewall of the portable module of the series of portable modules and the other outlet port of the pair of outlet ports is in the another defined position on the another sidewall of the portable module of the series of portable modules opposite the sidewall of the portable module of the series of portable modules;
the pair of inlet ports are fluidically connected to each other within the portable module of the series of portable modules; and
the pair of outlet ports are fluidically connected to each other within the portable module of the series of portable modules.

43. A method of providing a portable water treatment system comprising:
establishing a stock of a portable modules where each portable module provides a water treatment task of a series of water treatment tasks, defines an enclosed interior space housing a number of interconnected water treatment components where the interconnected water treatment components are selected in dependence upon the water treatment task of the series of water treatment tasks and are disposed between a number of inlet ports of the portable module and a number of outlet ports of the portable module portable modules;
receiving a requirement for the portable water treatment system comprising a series of portable modules where the requirement defines a number of types of portable module and a number of portable modules of that type of portable modules;
shipping the series of portable modules to a location; and
interconnecting the series of portable modules using standard pipe fitting according to the requirement at the location; wherein
each portable module incorporates a control module controlling operation of a subset of the number of interconnected water treatment components within the portable module, controlling operation of number of control components within the portable module, receiving data from at least one of another subset of the number of interconnected water treatment components, a subset of the number of control components and a number of sensors and providing data to a control system;
the series of portable modules are configured and interconnected in dependence upon one or more requirements specified for the portable water treatment system where the interconnections are established via a set of exterior pipes connecting to the number of inlet ports and the number of outlet ports of each portable module;
one or more inlet ports of the number of inlet ports of a defined portable module of the series of portable modules receive water for treatment from a water source whilst one or more outlet ports of the number of outlet ports of another defined portable module of the series of portable modules provided treated water to a subsequent water system; and
a control system operatively linked to each control module of the series of portable modules to provide overall management and control of the portable water treatment system.

44. The method according to claim 43, wherein
each type of portable module is selected from the group comprising a pumping module, a chemical dosing module, a chemical storage tank module, a sludge waste module, a sludge extraction module, a valve module, a pump module, a filtering module, a filtration module, a chemical dosing module, a mixing module, an air supply module, an aeration module, a compressor module, and a well head enclosure module.

45. The method according to claim 43, wherein
each portable module comprises automation equipment coupled to the control module directly or via one or more controllers such that the portable module is capable of automating and controlling the interconnected water treatment components to perform the water treatment task of the series of water treatment tasks as a standalone system or as part of a series of portable water treatment systems of which the portable water treatment system is one.
